(19) United States
(12) Patent Application Publication
(10) Pub. No.: US 2001/0056164 A1
(43) Pub. Date: Dec. 27, 2001

(54) Inhibitors and their uses in oils

(75) Inventors: Simon Neil Duncum, Bracknell (GB); Philip Kenneth Gordon Hodgson, Walton-on-Thames (GB); Keith James, Banstead (GB); Christopher George Osborne, Sandhurst (GB)

Correspondence Address: Nixon & Vanderhye P.C., 1100 N. Glebe Road, 8th Floor, Arlington, VA, 22201, US

(73) Assignee: BP Exploration Operating Company Limited

(21) Appl. No.: 09/853,600

(22) Filed: May 14, 2001

Related U.S. Application Data
(63) Continuation of application No. 09/311,161, filed on May 13, 1999.

(30) Foreign Application Priority Data
Nov. 14, 1996 (GB) 9623742.5
Nov. 14, 1996 (GB) 9623736.6
Dec. 20, 1996 (GB) 9626443.7
May 2, 1997 (GB) 9709064.1
Jun. 27, 1997 (GB) 9713709.5

(51) Int. Cl. C08F 220/10; C08F 18/00

(52) U.S. Cl. 526/319; 526/318.4; 526/318.44; 526/320

(57) ABSTRACT

Inhibitors of wax deposition for crude oils are polymers of a monomer with structural units derived from at least one ester (i) of an aliphatic carboxylic acid with an aliphatic alcohol, wherein one of the acid and alcohol is ethylenically unsaturated and the other of the acid and alcohol has a long chain group of 14-40 carbons, and a monomer with structural units derived from a corresponding ester (3) with structural units derived from an aliphatic carboxylic acid and an aliphatic alcohol, wherein one of the acid and alcohol is ethylenically unsaturated and the other has an aliphatic group of 1-13 carbons, such that at least 30% preferably 50-90% of the said aliphatic groups have 15-35 carbons. They are preferably made by transesterification. Blends of such polymers and/or the corresponding homopolymers or copolymers of ester 1 and/or polyalkylene imines with long side chains, and optionally with monomeric polar additives may be used as inhibitors.

The present invention relates to wax inhibitors especially wax deposition inhibitors and their use, particularly in petroleum industry pipelines.

Crude oils are complex mixtures comprising hydrocarbons of varying types and molecular weights. One class of hydrocarbon present in the oils is paraffins which are linear, branched chain or cyclic hydrocarbons having at least 18 carbons which can form waxy solids. The solubility of these waxy solid forming components in the crude oils is predominantly temperature-dependant. They are usually soluble in the crude oil under down-hole conditions i.e. high pressures or high temperatures. However as the oil is brought to the surface its temperature and pressure are reduced. As a result the wax may begin to precipitate out and may form deposits on any cooler surface with which it comes into contact. These wax deposits can cause problems, such as blockage of pipelines, valves and other process equipment. The wax may also deposit in pipelines subsequently used to transport crude oil or fractions derived from the total product brought up from down-hole, such as fractions comprising gas, e.g. natural gas, and/or water, as well as a liquid hydrocarbon body, e.g. crude (or black) oil or “condensate”; the pipelines may thus be hydrocarbon lines or multi phase transportation lines with oil, gas and/or water. The wax may deposit on surfaces of metal e.g. of ferrous metal.

The contents of the transport pipelines are often cooler than the contents of lines on oil platforms or in refineries. This cooling is especially critical in respect of lines from offshore oil fields to the land and land lines in cold territories such as Alaska.

Wax deposition may be reduced in a number of ways, including keeping the lines hot, diluting the oil with solvent, use of special additives which interfere with wax crystal growth.

We have discovered how to reduce the tendency to deposit wax from waxy oils.

The present invention provides a polymer of a monomer with structural units derived from an ester (1) of an aliphatic carboxylic acid with an aliphatic alcohol, wherein one of the acid and alcohol is ethylenically unsaturated and the other of the acid and alcohol has a long chain group e.g. of 14-40 carbons,

and optionally at least one monomer, which is a monomer with structural units derived from a different ester (2) within the same defintion as ester 1, such that the mole average carbon content of the long chain group is 15-35 preferably 16.5-24 especially 17.5-22 or that 30% e.g. at least 50% of the long chain groups have 15-35 carbons preferably 16.5-24 especially 18-22 carbons.

and/or a monomer with structural units derived from a corresponding ester (3) with structural units derived from an aliphatic carboxylic acid and an aliphatic alcohol, wherein one of the acid and alcohol is ethylenically unsaturated and the other has an aliphatic group e.g. of 1-13 carbons, such that at least 30% e.g. at least 50% of the total aliphatic groups in the polymer have 15-35 carbons preferably 16.5-24 especially 18-22 carbons. The polymers or copolymers may be made by direct (Co)polymerisation, but are preferably polymers obtainable by or obtained by transesterification of at least one polymer of an ester (3) with an aliphatic alcohol or carboxylic acid having an aliphatic group of 14-40 or 15-35 e.g. 16-24 carbons (depending on whether the acid or alcohol in ester 1 is unsaturated or aliphatic); the conversion may be substantially complete, but preferably is only 30-90% e.g. 40-90% or 50-90%.

The present invention also provides said transesterification process.

The present invention provides a blend of at least two different polymers selected from homopolymers (A) with structural units derived from an ester (1) and copolymers (B) thereof with structural units derived from a difTerent ester (2) within the same definition as ester 1, such that the mole average carbon content of the long chain group is 15-35 preferably 16.5-24 especially 17.5-22 or that at least 30% e.g. at least 50% of the long chain groups have 15-35 carbons preferably 16.5-24 especially 18-22 carbons, and copolymers (C) of said ester (1) and optionally ester (2) with a corresponding ester (3) such that at least 30% e.g. at least 50% of the said aliphatic groups have 15-35 carbons preferably 16.5-24 especially 18-22 carbons.

The present invention also provides at least one copolymer C. The present invention also provides a blend of components selected from:

a) component (I), which is at least one N-substituted polyalkyleneimiine compound with chain nitrogen atoms, which has at least one organic substituent of at least 6 carbon atoms on at least one nitrogen atom and

b) component (II) selected from at least one polymer of said homopolymers (A), copolymers (B) and copolymers (C) with the proviso that the blend comprises at least 2 components of which at least one is a component (I).

The blends of the invention may comprise at least two components (I) or may comprise at least one component (I) together with at least one component (II). Preferably the blend comprises a component (I) with at least one component (II)

which is preferably copolymer (C) and at least one of polymer (A) and (C).

The present invention also provides a composition comprising at least one polymer A, B or C or said blend, together with at least one monomeric additive, which has an aliphatic group of at least 14 carbons and a polar group, preferably a group containing one or more nitrogen atoms, especially with at least one tertiary or secondary amino nitrogen (and optionally in addition a primary) amino nitrogen atom, in particular in a heterocyclic group containing at least 1 nitrogen atom.

The present invention also provides a method of reducing wax formation and/or deposition in a wax-containing oil, preferably in a pipeline containing said oil, while flowing, which comprises mixing with said oil at least one polymer A, copolymer B or C, blend or composition of the invention.

Ester 1 may be derived from an ethylenically unsaturated carboxylic acid and a long chain alcohol, whether saturated or unsaturated and in this case ester 2 and/or ester 3 (if present) are of this same type with a long chain alcohol or short chain alcohol whether saturated or unsaturated. Alternatively ester 1 may be derived from an ethylenically unsaturated alcohol e.g. “vinyl alcohol” and a long chain aliphatic carboxvlic acid whether saturated or unsaturated, and in this case ester 2 and/or ester 3 if present are of this same type with a long chain acid or shor chain acid whether saturated or unsaturated.

In the blends of the invention of at least 2 polymers selected from homopolymers A, copolymers B and copolymers C, ones with copolymer C and at least one of A, B and C are preferred. Preferred blends have a bimodal distribution of carbon numbers in the 14-40 region for alcohols when the acid is unsaturated or for acids the “alcohol” is unsaturated.

The above copolymers C are preferably obtainable by or obtained by transesterification of at least one polymer of an ester (3) with an aliphatic alcohol or carboxylic acid having an aliphatic group of 14-40 e.g. 16-24carbons (depending on whether the acid or alcohol is unsaturated); the conversion may be substantially complete, but preferably is only 30-90%, 40-90% or especially 50-90%. The transesterification product may be used as such i.e. containing any unreacted polymer of ester (3) and/or unreacted alcohol or acid (respectively) with a 14-40 e.g. 16-24 carbon group, e.g. in amount of 1-50% e.g. 10-50% (by weight, based on the weight of polymer 3) especially for unreacted alcohol. The unreacted alcohol or acid respectively may be substantially removed so the product may be in the substantial absence of said alcohol or acid.

The ethylenic unsaturated carboxylic acid for use in ihe ester polymers may contain the unsaturated group alpha, beta or gamma, or in another location, to the carboxylic group. It may contain 3-6 carbon atoms, and is especially an aliphatic alpha ethylenically unsaturated carboxylic acid of formula CH₂═CR⁶CO₂H, wherein R⁶ is hydrogen or an alkyl group of 1-3 carbons, e.g. methyl, ethyl or propyl. Methacrylic and especially acrylic acids are preferred. The acid may be a mono, di or tricarboxylic acid, examples of the diacid being fulmaric, maleic and crotonic acids.

In the polymers A, B and C, each of the long chain groups may be saturated or ethylenically unsaturated, but are preferably all saturated or all unsaturated, though at least one may be unsaturated and the rest saturated.

The long chain aliphatic alcohol for use in the ester polymers is preferably linear, but may be branched (e.g. with a branch methyl group). The alcohol may be saturated i.e. an alkanol in which case preferably at least 40% of the saturated aliphatic groups have 15-35 carbons in particular when the copolymer consists essentially of units of esters 1 and 3. The alcohol may be ethylenically unsaturated i.e. an alkenol in which case preferably at least 50% of the aliphatic groups in the copolymer have 15-35 carbons and the molecular weight is at least 5000, e.g. at least 20,000 or 40,000 especially at least 5000 when the copolymer consists essentially of structural units from ester 1 and 3. The alcohol may contain at least one unsaturated group e.g 1-4 such as 1 or 2 or 3 or 4, especially 1 unsaturated group. The unsaturated group may be beta, gamma, or in another location, to the alcohol group. Preferably at least one unsaturated group is a non-terminal unsaturated group, wherein each unsaturated group may be spaced from the alcohol group by 2-16 carbons, in particular 4-10 carbons and spaced from the terminal carbon by 2-16 carbons, in particular by 4-10 carbons. The unsaturated group may have a cis or trans configuration or when more than one unsaturated group is present each may have a cis or trans configuration; the unsaturated groups may be conjugated or non-conjugated, especially separated by 1-3 e.g 1 carbon atom. The alcohol usually contains 14-40 carbons such as 15-25 carbons, especially 16, 18, 20, 22 or 24 carbons. The alcohol may be natural or synthetic e.g. from oxo or ALFOL processes. Examples of suitable alcohols are palmityl, hexadecyl, stearyl, octadecyl, eicosyl, docosyl, tetracosyl, hexacosyl, octacosyl and triacontyl alcohols, as well as oleyl alcohol and branched alcohols such as oxo alcohols e.g. 2-methyl eicosyl alcohol. Examples of suitable unsaturated alcohols are palmitoleyl alcohol, hexadecenoyl alcohol, oleyl alcohol, linolenyl alcohol, linoleyl alcohol, ricinoleyl, octadecenoyl alcohol, docosenyl alcohol, arachidonyl alcohol and tetracosenyl alcohol. The alcohols saturated or unsaturated may be substantially pure, but are preferably mixtures of alcohols, e.g. as in tallow alcohol or mixtures of alkanols or alkenols of even carbon number, with one carbon number predominating with decreasing proportions of alkanols or alkenols of lower and higher carbon number (e.g. of Gaussian distribution) i.e. with carbon numbers distributed on either side of the major one. Such mixtures may contain at least 50% e.g. at least 80 or 90% (by mole) of one alkanol or alkenol. Examples of such mixtures are unsaturated alcohols e.g of 16 or 18 carbon atoms containing in wt % 50-100% of cis-alkenol, 1-15% e.g. 5-15% of trans-alkenol, 1-15% e.g. 5-15% of non-conjugated dieneols, 0.1-5% e.g. 1-5% of conjugated dieneols and optionally 1-20% e.g. 5-20% of saturated alkanols, especially C14, C16 or C18 saturated alkanols (such as in commercial oleyl alcohol), and/or saturated alcohols e.g. commercial behenyl alcohol with a majority of a 22 carbon alkanol and smaller amounts of 16, 18, 20 and 24 carbon alkanols.

To make the ester polymer there may also be used a mixture of alcohols (saturated or unsaturated) with a bimodal distribution of the carbon number content, e.g. with at least 25% moles of each of 2 alcohols, especially alcohols different in at least 1, or at least 3 carbons, such as 1-9 e.g. 2 or especially 3-7 e.g. 4 or 6 carbons. Examples of such mixtures are for alkanols palmityl/stearyl alcohols and mixtures of hexadecyl/octadecyl, hexadecyl/eicosyl, hexadecyl/docosyl, octadecyl/eicosyl, octadecyl/docosyl, octadecyl/tetracosyl and eicosyl/dosocyl and eicosyl/tetracosyl alcohols. Other Examples of such mixtures are oleyl/linoleyl alcohols and mixtures of oleyl/linolenyl, linoleyl/linolenyl, oleyl/ricinoleyl, linolenyl/ricinoleyl, linoleyl/ricinoleyl, palmitoleyl/oleyl, palmitoleyl/linolenyl, paliitoleyl/linoleyl, palrnitoleyl/ricinoleyl, oleyl/arachidonyl, linolenyl/arachidonyl, linoleyl/arachidonyl, ricinoleyl/arachidonyl, and palmitoleyl/arachidonyl, hexadecenoyl/octadecenoyl, hexadecenoyl/eicosenoyl, hexadecenoyl/docosenoyl, octadecenoyl/eicosenoyl, octadecenoyl/docosenoyl, octadecenoyl/tetracosenoyl and eicosenoyl/docosenoyl and eicosenoyl/tetracosenoyl, paliityl/oleyl, hexadecenyl/octadecyl, hexadecenyl/eicosyl, hexadecenyl/docosyl, octadecenyl/eicosyl, octadecenyl/docosyl, octadecenyl/tetracosyl, oleyl/octadecyl, oleyl/docosyl, oleyl/eicosyl, linoleyl/octadecyl, linoleyl/docosyl, linoleyl/eicosyl, linoleny/octadecyl, linolenyl/docosyl, linolenyl/eicosyl, ricinoleyl/octadecyl, ricinoleyl/docosyl, ricinoleyl/eicosyl, arachidonyl/octadecyl and arachidonyll/docosyl and arachidonyl/eicosyl alcohols.

Mixtures of alcohols may also contain at least 20% of each of 2 alcohols and usually at least 30% of at least one alcohol; examples of these are mixtures of 16/28, 16/18/20, 18/20/22, 20/22/24 alkanols, e.g. as sold by Condea Germany.

In addition to the long chain ester monomer units in the polymers and copolymers, there preferably are short chain ester monomer units.

Preferably the polymers and copolymers consist essentially of structural units derived from the esters 1 and/or 2 but they may also contain structural units derived from esters(3) from a short chain aliphatic alcohol, such as a linear or branched one and saturated or unsaturated in which case the copolymers consist essentially of units derived from esters 1 and/or 2 with 3 especially units derived from esters 1 and 3. Examples of such alcohols are alkanols of 1-6 carbons, such as methanol, ethanol, n-propanol, n-butanol, iso, sec. and tert. butanol, pentanol and hexanols; methanol or t-butanol are preferred.

The ethylenically unsaturated aicohol providing structural units for use in the ester polymers may contain the unsaturated group, alpha, beta or gamma to the alcohol group or in another location. It may contain 2-6 carbons, and is preferably allyl alcohol, methallyl alcohol, alpha methyl vinyl alcohol or especially “vinyl alcohol” (CH₂═CHOH), which can form structural units for the ester polymers.

The long chain aliphatic acid for use in the ester polymers is preferably linear, but may be branched (e.g. with a branch methyl group). The acid may be saturated i.e. an alkanoic acid or ethylenically unsaturated i.e. an alkenoic acid. It may contain at least one unsaturated group e.g 1-4 such as 1 or 2 or 3 or 4, especially 1 unsaturated group. The unsaturated group may be beta, gamma, or in another location, to the carboxylic group or when more than one ethylenically unsaturated group is present, a mixture therof. Preferably at least one unsaturated group is a non-terminal unsaturated group, wherein each unsaturated group may be spaced from the alcohol group by 2-16 carbons, in particular 4-10 carbons and spaced from the terminal carbon by 2-16 carbons, in particular by 4-10 carbons. The unsaturated group may have a cis or trans configuration or when more than one ethylenically unsaturated group is present each may have a cis or trans configuration; the unsaturated group may be conjugated or non-conjugated, especially separated by 1-3 e.g. 1 carbon atom. The acid usually contains 14-40 carbons such as 15-25 carbons, especially 16, 18, 20, 22, or 24 carbons. The saturated or unsaturated acid may be natural or synthetic e.g. derived from oxo or ALFOL process alcohols. Examples of suitable unsaturated acids are palmitoleic, hexadecenoic, oleic, octadecenoic, eicosenoic, docosenoic, tetracosenoic, linoleic, linolenic and arachidonoic acids. Examples of suitable saturated acids are palmitic, hexadecanoic, stearic, octadecanoic, eicosanoic, docosanoic, tetracosanoic, hexacosanoic, octacosanoic and triacontanoic. The saturated or unsaturated acids may be substantially pure, but are preferably mixtures of acids, e.g. as in tallow acid or mixtures of acids of even carbon number with one carbon number predominating with decreasing proportions or acids or lower and higher carbon number (e.g. of Gaussian distribution) i.e. with carbon numbers distributed on either side of the major one. Such mixtures may contain at least 50% e.g. at least 80 or 90% (by mole) of one alkanoic or alkenoic acid and smaller amount(s) of other alkanoic or alkenoic acid(s). Examples of such mixtures are unsaturated acids e,g of 16 or 18 carbons containing (in wt %) 50-100% cis-acid, 1-15% e.g. 5-15% of trans-acid, 1-15% e.g. 5-15% non-conjugated diacids, 0.1-5% e.g. 1-5% of conjugated diacids (such as in commercial oleic acid) or saturated acids e.g. behenic acid with a majority of 22 carbon alkanoic acid and smaller amounts of 16, 18, 20 and 24 carbon alkanoic acids.

To make this kind of ester polymer there may also be used a mixture of acids with a bimodal distribution of the carbon number content, e.g. with at least 25% moles of each of 2 acids, especially acids different in at least 1, or at least 3 carbons, such as 1-9 or especially 3-7 carbons. Examples of such mixtures are palmityl/stearic acids and mixtures of hexadecanoic/octadecanoic, hexadecanoic/eicosanoic, hexadecanoic/docosanoic, octadecanoic/eicosanoic, octadecanoic/docosanoic, octadecanoic/tetracosanoic and eicosanoic/docosanoic and eicosanoic/tetracosanoic acids. Other examples of such mixtures palmitoleic/oleic acids and mixtures of oleic/linoleic, oleic/linolenic, linoleic/linolenic, oleic/ricinoleic, linolenic/ricinoleic, linoleic/ricinoleic, palmitoleic/linolenic, palmitoleic/linoleic, palmitoleic/ricinoleic, oleic/arachidonic, linolenic/arachidonic, linoleicl/arachidonic, ricinoleic/arachidonic, palmitoleic/arachidonic, hexadecenoic/octadecenoic, hexadecenoic/eicosenoic, hexadecenoic/docosenoic, octadecenoic/eicosenoic, octadecenoic/docosenoic, octadecenoic/tetracosenoic and eicosenoic/docosenoic and eicosenoic/tetracosenoic, palmityl/oleic, hexadecanoic/oleic, hexadecanoic/linoleic, hexadecanoic/linolenic, hexadecanoic/ricinoleic, hexadecanoic/arachinoic, octadecanoic/oleic, octadecanoic/palmitoleic, octadecanoic/linoleic and octadecanoic/linolenai octadecanoic/ricinoleic, octadecanoic/arachinoic, docosanoic/oleic, docosanoic/linoleic, docosanoic/linolenoic, docosanoic/ricinoleic, docosanoic/arachinoic, eicosanoic/oleic, eicosanoic/linoleic, eicosanoicl/inolenoic, eicosanoic/ricinoleic, eicosanoic/arachanoic, tetracosanoic/oleic, tetracosanoic/linoleic, tetracosanoic/linolenoic and tetracosanoic/ricinoleic and tetracosanoic/arachinoic acids.

In addition to the long chain ester monomer units in the polymers and copolymers, there may also be short chain ester monomer units.

Preferably the polymers and copolymers consist essentially of structural units derived from the esters 1 and/or 2, but they may also contain structural units derived from esters (3) from a short chain aliphatic acid, such as a linear or branched one, and saturated or unsaturated, in which case the copolymers consist essentially of units derived from esters 1 and/or 2 with 3 especially units derived from esters 1 and 3. Examples of such acids are alkanoic acids of 1-6 carbons, such as formic, acetic, propionic, butyric/isobutyric, pentanoic and n-hexanoic acids; acetic and propionic acids are preferred.

In the polymers B, structural units from alcohols or acids of different carbon number may be present in the same polymer, especially those with a bimodal distribution of alcohol/acid carbon number.

Preferably a blend of polymers is used in which each polymer has an essentially unimodal distribution of alcohol/acid carbon numbers in the 16-40 range, and such that there is an overall bimodal distribution of alcohol/acid carbon numbers in the polymers combined. Blends of 2 of these unimodal polymers may contain them in a 10-90:90-10 e.g. 20-80:80-20 molar ratio e.g. so that the average carbon chain length of the long chain aliphatic groups is 14-25 or 15-24 preferably 15.5-22.5 (or 16.5-22.5) particularly 16.5-22.0 (or 17.5-22.0) especially 17.5-21.0 (or 18.5-21.5) (in particular for oils of WAT 20-50° C. and pour point −20 to +20° C.); the ranges in brackets are particularly preferred for ester polymer derived from long chain alcohols. Pour points were measured as defined in the ASTM Standard. In addition to this distribution of long chain carbon numbers, the polymers may also contain structural units from alcohols or acids of 1-6 carbons, so the distribution may be trimodal or higher modal e.g. when the polymers contain units from esters 1, 2 and 3; in this case the average carbon chain of the aliphatic side chains is 11-18 (or 12-18) e.g. 11.5-17.5 (or 13.0-16.0) especially 12.5-17.0 (or 13.5-15.5) particularly for oils of WAT20-45° C. and pour point −20 to +20° C.; the ranges in brackets are particularly preferred for ester polymer derived from long chain alcohols, whether saturated or unsaturated.

Preferred polymers A and B are those from acrylates of eicosyl alcohol and behenyl alcohol, especially with at least 80% of 20 and/or 22 carbon alcohols respectively and at most 10% molar of any alcohol with 2 or 4 carbons higher or lower than 20 or 22 respectively, and from acrylates of oleyl alcohol, and iinoleyl alcohol, especially with at least 70% of the 18 carbon alcohol and at most 20% molar of any alcohol with the same number of carbons or 2 or 4 carbons higher or lower than 18 carbons.

Preferred copolymers C are those D with structural units from the above acrylates and structural units from at least one acrylate of an alcohol of 1-6 carbons, such as methanol or ethanol. The preferred copolymers C contain 50-90% molar of units from alcohols of 14-40 e.g. 16-24 carbons and 10-50% molar of units from the alcohol of 1-6 carbons. Of these 14-40 e.g. 16-24 carbon alcohols, at least 80% are preferably of 1 particular carbon number especially 16, 18, 20 or 22 in particular 20. Particularly preferred are blends of copolymers C e.g. at least 2C particularly the above copolymers D, especially blends of polymer of unimodal distribution (with respect to 14-40 carbon alcohols content) with a molar ratio of structural units derived primarily from alcohols of a higher carbon number to those of the lower of 10-90:90-10 e.g. 30-70:70-30.

Preferred polymers A¹ and B¹ are those from the vinyl esters of stearic, octadecanoic or eicosanoic and behenic acids, especially with at least 80% of 20 or 22 carbon acids and at most 5% molar of any alkanoic acid with 2 or 4 carbons higher or lower than 20 or 22 respectively, and those from the vinyl esters of oleic, and linoleic acids, especially with at least 80% of 18 carbon acids and at most 5% molar of any alkenoic acid with the same number of carbons or 2 or 4 carbons higher or lower than 18 carbons.

Preferred copolymers C¹ are those D¹ with structural units from the above vinyl esters and structural units from at least one vinyl ester of an acid of 1-6 carbons, such as acetic. The preferred copolymer C¹ contain 50-90% molar of units from alkanoic or alkenoic acids of 14-40 carbons and 10-50% molar of units from the acid of 1-6 carbons. Of these 14-40 carbon acids, at least 80% are preferably of 1 particular carbon number. Particularly preferred are biends of copolymers C¹ e.g. at least 2C¹ particularly the above copolymers D¹, especially blends of polymer of unimodal distribution (with respect to 14-40 carbon acids content) with a molar ratio of structural units derived primarily from acids of a higher carbon number of those of the lower of 10-90:90-10 e.g. 30-70:70-30.

The polymers and copolymers A, B, C, D, A¹, B¹, C¹ and D¹, may contain structural units from other unsaturated monomers e.g. ones monomers containing at least one N and/or S atom or O atom in an ether linkage, e.g. an amount of up to 10% by weight based on the total weight of structural units, but preferably structural units from such monomers are substantially absent.

The polymers and copolymers may be made directly from the corresponding ester(s) and polymerisation e.g. ester 1 alone or with ester 2 and/or 3 especially esters 1 and 3. The polymers and coppolymers may be made by transesterification of the corresponding ester polymers (3) from an alcohol or acid of 1-13 carbons e.g. 1-6 with the long chain aliphatic alcohol (saturated or unsaturated) or mixture thereof, or long chain aliphatic acid (saturated or unsaturated) or mixture thereof. The ester polymers used as feed for the transesterification preferably consist essentially of structural units from said ester (3).

The polymerisation (including copolymerisation) may be performed in a conventional manner e.g. with or without a diluent e.g. a hydrocarbon solvent, such as hexane, heptane, or a higher boiling hydrocarbon oil, at a temperature of 25-120° C., such as 60-100° C., and optionally in the presence of a free radical catalyst, such as a peroxide (e.g. benzoyl peroxide) or azo catalyst such as azobis isobutyronitrile. The polymerisation is usually performed under inert conditions e.g. under nitrogen or argon. The polymerisation time may be 0.5-40 hr, preferably 5-25 hr at 60-100° C. At the end of the polymerisation, the reaction product may be purified by evaporation under vacuum to remove unreacted monomer, and/or precipitation of the product with methanol from a liquid aromatic or aliphatic hydrocarbon solution of the product. The copolymerisation may be performed with monomer of ester 1 and monomer of ester 3 in a mole ratio of30-90:10-70 e.g. 50-90:10-50 e.g. such as 55-75:45-25 or 70-90:10-30.

The transesterification may be performed in the absence of but preferably in the presence of a liquid aromatic or aliphatic hydrocarbon solvent, by reaction of a lower alkyl ester polymer(or lower alkanoic acid ester polymer) with the higher alcohol or alcohols ( or higher acid or acids respectively). The transesterification may be performed with an amount of the long chain alcohol (or acid) substantially corresponding to the amount needed for the degree of conversion required, or an amount in excess of this e.g. substantially corresponding to an equimolar amount (based on the units of ester 3 in the starting polymer) may be used and the reaction stopped when the desired degree of transesterification has occurred e.g. as found from the amount of distilled by product lower alcohol or acid. The reaction may be performed at 50-150° C. e.g. 60-120° C. for 1-30 e.g. 5-20 hours, in the absence or presence of a catalyst e.g. an organic soluble strong acid such as an aromatic sulphuric acid e.g. p-toluene sulphonic acid or a basic catalyst, such as an alkali metal alkoxide e.g. sodium methoxide or ethoxide (added as such or prepared in situ from alkali metal and by product lower alkanol) or a polyvalent metal alkoxide such as tetra methyl or tetra ethyl titanate. Amounts of the basic catalyst e.g. alkali metal alkoxide may be 0.05-5% e.g. 0.1-1% by weight of the feed polymer. During the reaction the by product lower alcohol or lower acid is preferably evaporated. At the end, any solvent is advantageously evaporated, while optionally unreacted higher alcohol or acid may be evaporated e.g. under reduced pressure. The transesterification may be performed substantially to completion e.g. 90-100% especially 95%-100%, with substantially no unreacted starting polymer e.g. 0-10% especially 0-5%, but advantageously the amount of reaction is 50-90% e.g. 55-75% or 70-90%.

The copolymer product, whether of the direct copolymerisation or transesterification can contain (in relation to the aliphatic side chains) 10-70% or 10-60% e.g. 10-50% short chain e.g. methyl ester groups and 30-90% or 40-90% e.g. 50-90% long chain chain e.g. 25-45% or 10-30% short and 55-75% or 70-90% long chain. Preferred products whether of a direct copolymerisation or transesterification are ones with an average aliphatic side chain length of 12-19 carbons e.g. 14.5-18.5 or 15.5-18 especially for allyl and alkenyl esters and advantageously for oils of WAT 20-45° C. and pour point −20 to +20° C.

Particularly preferred are blends of 2 or more copolymers C (or copolymers C¹), each obtained by or obtainable by direct copolymerisation or especially transesterification and each derived from an ester 3 which was the lower alkyl ester (or lower alkanoic ester) e.g. (m)ethyl (meth)acrylate with the long chain aliphatic alcohol of 14-40 carbons, or of vinyl acetate with the long chain aliphatic carboxylic acid of 14-40 carbons respectively), especially ones substantially pure or with a substantial unimodal carbon number distribution. In particular the transesterification is performed to 30-90%, 40-90 or preferably 50-90% completion, with evaporation of by product alcohol or acid, and with or without removal of unreacted higher alcohol or acid. The preferred copolymers, especially each transesterification product, comprise a mixture of polymers with (as far as the aliphatic side chains are concerned) 30-90% e.g. 50-90% of long chain groups (whether saturated or ethylenically unsaturated) and 10-70% e.g. 10-50% of unreacted short chain e.g. lower alkyl ester groups, especially preferred are mixtures with 60-80% or 75-95% long chain groups and 40-20% or 5-25% unreacted short chain groups. Most preferred are blends of copolymers of esters 1 and 3 in particular partial transesterification products with side chains of methyl and C₂₀, and also methyl and C₁₆ or C₁₈ or C₂₂, especially with average alkyl or alkenyl side chain lengths of 15.5-19 especially 16-18, in particular with esters from long chain alcohols (saturated or unsaturated).

The blends of polymers involve at least two polymers selected from A, B and C and include blends of polymers differing in the nature and/or proportion of their structural units and/or in their molecular weight especially blends of polymers C differing in the length of the chains in their structural units. The polymers, especially polymer C may also differ in their manufacturing route, i.e. direct or transesterification but both are preferably the same, especially transesterification.

The polymers of the present invention may have a molecular weight of 500 to 200,000, e.g. 500 to 39,999, preferably 5,000 to 35,000 and especially 20,000 to 30,000 or for example 40,000 to 200,000, preferably 80,000 to 160,000(Mw, weight average molecular weight) and the molecular weight distribution (Mw/Mn) may be 1.2-20 e.g. 1.2-10, preferably, 1.4-2 or 2-20 e.g. 5-15. As used herein, unless otherwise specified, the term “Molecular Weight” of an ester polymer produced by transesterification of the corresponding precursor ester polymer means the weight average molecular weight of the ester polymer obtained by calculation from the percentage conversion (based on spectroscopic analysis) and the molecular weight of the precursor ester polymer or the weight average molecular weight of the ester polymer itself, the molecular weight being determined by gel permeation chromatography (GPC) against polystyrene standards as described in the Aldrich Chemical Company's Standard Test Method for GPC; the term “Molecular Weight” of an ester polymer produced by direct polymerisation of the corresponding ester means the weight average molecular weight of the ester polymer determined by gel permeation chromatography (GPC) against polystyrene standards as described in the Aldrich Chemical Company's Standard Test Method for GPC

The compositions of the invention usually contains the polymer A B and/or C and/or component I and at least one monomeric additive with a long chain hydrocarbyl group and a polar group. The additive is oil soluble e.g. soluble in diesel oil at 25° C. to at least 1 g/l e.g. at least 10 g/l. The additive preferably has surfactant activity and especially surface wetting activity.

The hydrocarbyl group in the additive may be linear or branched aliphatic, e.g. alkyl or alkenyl with at least 10 carbons such as 14-30 e.g. 16-24; examples are dodecyl, cetyl, stearyl, palmityl, tallyl, and hydrogenated tallyl and oleyl. The polar group may contain at least one oxygen atom e.g. in an ether or alcohol group such as a hydroxyl or 2-hydroxyethyl group, and/or at least 1 e.g. 1-4 nitrogen atoms e.g. in a primary secondary and/or tertiary amine or amide group, especially one nitrogen atom in a primary amine and one nitrogen atom in a secondary or tertiary amine or amide in particular in a non cyclic structure, or with one nitrogen atom in a primary amine and/or 2 nitrogen atoms in a tertiary amine, in particular in a heterocyclic compound.

The additive may be a long chain substituted amine with 2 or more nitrogens, in particular ones with the long chain hydrocarbyl group attached directly to one nitrogen atom, preferably in an NH group, and with a primary amine NH₂ group elsewhere in the molecule, especially separated from the long chain group by the NH group. Such additives may be of formula

R—NH—(CₙH₂ₙNH)ₘ CₚH₂ₚNH₂ (I)

wherein R is a long chain hydrocarbyl group e.g. as defined above, n and p are integers of 2-5 especially 2 or 3 and m is O or an integer of 1-8 e.g. 1-6 such as 0, 1 or 2. Preferred additives are mono N-terminal hydrocarbyl derivatives of 1,2-ethylene diamine, 1,2- and 1,3-propylenediamine and 1,2-, 1,3- or 1,4-butylenediamine, as well as diethylene triamine and triethylene tetrarnine. Examples ofsuch compound are mono- terminal N hydrocarbyl derivatives of 1.3-propylene diamine and diethylenetriamine, in particular where the aliphatic group is alkyl or alkenyl e.g. stearyl, oleyl, “tallyl” (i.e. a mixture of stearyl, palmityl and oleyl) and hydrogenated tallyl (a mixture of stearyl and palmityl); mono terminal N-hydrogenated tallyl-1,3-propylene diamine is preferred.

The additive may also be the corresponding long chain amido amine e.g. of formula

RCO NH (CₙH₂ₙNH)ₘCₚH₂ₚNH₂ (II)

where R, n, m and p are as defined above. Preferred are the amido analogues of the above amines, especially N-tallowyl-1,3-propylene diamine.

The additive may also be a hydroxy alkyl or amino alkyl derivative of either the long chain amine or long chain amido amine. Such additives may be of formula

R—(CO)ₐ—N(R¹)—(CₙH₂ₙNR²—)ₘ CₚH₂ₚNR³R⁴ (III)

where R, m, n and p are as defined above, and each of R¹, R², R³ and R⁴ which is the same or different represents hydrogen or (C_{b}H_{2b}NR²)ᵣ C_{c}H_{2c}NR³R⁴, or (C_{d}H_{2d}O)ₛCₑH₂ₑOH, and at least one of R¹-R⁴ does not represent hydrogen, wherein each of b, c, d, and e is as defined for n above and r and s are each as defined for m above and a is O or 1. Such additives are mono or poly alkoxylated or amino alkylated derivatives of the additives of formula I. Preferred are hydroxymethyl derivatives of those additives, especially wherein each of R¹ -R⁴ is hydroxymethyl. Preferred are N-tallyl (or tallowyl) 1,3-propylene diamine polyethoxylate with an average 2-6 eg 4-5 ethyleneoxy units and its hydrogenated derivative with saturated long chain alkyl groups.

The additive may be a long chain aliphatic hydrocarbyl N-heterocyclic compound, which is not quaternised. The aliphatic hydrocarbyl group in the heterocyclic compound usually has 8-24 carbons in the hydrocarbyl group, preferably a linear saturated or mono or diethylenically unsaturated hydrocarbyl group; cetyl-, stearyl and especially oleyl- groups are preferred. The N-heterocyclic compound usually has 1-3 ring N atoms, especially 1 or 2, which compound usually has 5-7 ring atoms in each of 1 or 2 rings; imidazole and imidazoline rings are preferred. The heterocyclic compound may have the aliphatic hydrocarbyl group on an N or preferably C atom in the ring; the ring may also have an amino-alkyl (e.g. 2-amino ethyl) or hydroxyallyl (e.g 2-hydroxyethyl) substituent, especially on an N atom. N-2-amiinoethyl-2-oleyl-imidazoline is preferred. The long chain amine usually contains 8-24 carbons and preferably is an aliphatic primary amine, which is especially saturated or mono ethylenically unsaturated; an examples is dodecylamine and oleylamine. Mixtures of any of the above additives with each other may be used.

If desired the additive e.g. a long chain amine may also comprise a phosphate ester salt, especially one with surface wetting activity. Such phosphate esters are anionic surfactants, which are salts of alkali metals e.g. sodium or a quaternary ammonium e.g. tetra methyl ammonium or tetrabutyl ammonium salts of acid phosphate esters, e.g. with 1 or 2 organic groups and 2 or 1 acidic hydrogen atoms; examples of the organic groups are alkyl or alkenyl groups as described for R above. Examples of such phosphate ester salts are mono and dioctyl acid phosphate salts and mixtures thereof. A preferred blend comprises a long chain alkylamine and a phosphate ester salt e.g. as sold as NAL 1272 by Nalco.

The amount of additive is usually in a weight ratio of 1:500 to 1:10 e.g. 1:50 to 1:15 by weight based on the total dry weight of the polymer.

In the substituted polyalkyleneimine of component (I) each alkylene group usually has 2-4 carbons, eg 2, 3 or 4 especially 2 carbons. The substituted polyalkyleneimine compound or polyalkyleneimine backbone thereof may have a molecular weight of 600-1000000 eg 800-100000 such as 1300-3000 but may be 200,000-500,000. The polyalkyleneimine backbone may be linear or branched; the back bone usually has linear and branched sections with branching on each 1-10 nitrogen atoms e.g. 2-5 N atoms. The compound is usually oil soluble to an extent of at least 0.05% w/w in decane at 0° C., preferably at least 1% w/w; it is usually water insoluble, eg with a solubility in water at 25° C. of less than 1% w/w, especially less than 0.05% w/w. The compound is usually a waxy solid, eg of softening point 20-100° C. e.g. 40-80° C.

The organic substituent in the substituted polyalkyleneimine may be of 6-40 carbon atoms, preferably with a continuous chain of at least 6, eg at least 12, such as 6-24 or 12-20 or 12-24 carbon atoms. The chain, and especially the organic substituent may be branched but is especially linear. The organic substituent may have such a chain bonded directly to a chain or terminal nitrogen atom of the polyatkylene imine or preferably bonded via an intermediate group usually a polar group. The intermediate group which is usually divalent, may be inorganic eg an ether oxygen atom or suiphonyl SO₂ group, or the intermediate group may be a functional group containing C and at least one O and/or N atom and optionally at least one hydrogen atom. Examples of such groups are carbonyl (—CO), including 2 hydroxycarbonyleth-1-yl-1-carbonyl (derived from a succinic acid group), a 2-hydroxy (or amino) alkylidene (1,1)- group, or 2-hydroxy(or amino) alkylene (1,2)- group (each alkylidene or alkylene having 2-4 e.g. 2 carbons) such as 2-hydroxy ethylidene HOCH₂—CH< or 2 hydroxyethylene —(HO)CH—CH₂— (or mixtures thereof) and the corresponding amino compounds (or mixtures thereof).

The organic substituent may also comprise a group A of at least 6 carbons which may be an alkyl group of 6-30 eg 12-24 carbon atoms, such as octyl, decyl, dodecyl/lauryl, tetradecyl, hexadecyl/palmityl, octadecyl/stearyl or may be an alkenyl group of 6-30 eg 12-24 carbon atoms such as octadecenyl, hexadecenyl or dodecenyl. The organic substituent may also comprise an aryl group A, eg an aromatic hydrocarbyl group, which may be optionally substituted by at least one ether group, eg alkoxy of 1-6 carbons such as methoxy or ethoxy; the aryl group may contain 6-30 carbons, such as 6-14 and especially 6-9 carbon atoms, preferably phenyl, tolyl, xylyl dodecyl-phenyl or naphthyl or methoxy phenyl. The organic substituent may also comprise a cycloalkyl group A eg of 5-10 carbons such as cyclopentyl or cyclohexyl, either of which may be substituted by at least one hydrocarbyl group eg alkyl of 1-6 carbons such as methyl, or alkoxy eg of 1-6 carbons such as methoxy or ethoxy. The organic substituent may also comprise an arylalkylene group A or cycloalkylalkylene group A each of 7 to 30 carbons eg 7-12 or 14-20 carbons, in which the aryl group and cycloalkyl groups may be as defined above and the alkylene group may contain 1-4 carbons, especially methylene and 1,2-ethylene, such as benzyl, 2-phenylethyl or cyclohexylmethyl. The organic substituent may also comprise an arylalkenylene group A, wherein aryl is as defined above and alkenylene has 2-4 carbons such as 1,2-ethylene as in 2-phenyleth-1-enyl.

The organic substituent preferably consists of said intermediate group and said group A or consists of said group A. However the organic substituent may also be a group B of formula R⁷—C—(R⁸)—R⁹, wherein R⁷ comprises an optionally hydroxy or amino substituted organic group (eg with at least one carbon atom, particularly as defined for A above), especially with the HO or H₂N group in the 2 or 1 position to the free valency such as hydroxy methyl or amino methyl and R⁸ may be hydrogen or an organic group (eg as defined for A above) and R⁹ may be hydrogen or an organic group (eg as defined for A above).

Examples of Component (I) are polyethyleneimines with at least one N-substituent which is a 1-alkyl or aryl 1-hydroxymethyl 1-methyl group eg 1-hexadecyl-1-hydroxymethyl 1-methyl group, 1-phenyl-1-hydroxymethyl-1-methyl group, or 2-alkyl or aryl- 2 hydroxy ethyl-1- group such as 2-hexadecyl-2 hydroxy ethyl (2 -hydroxy octadecyl) or 2-phenyl 2 hydroxy ethyl group, a fatty acid acyl group eg stearoyl or lauroyl, or arylacyl group eg benzoyl or arylalkylene acyl group e.g. cinnamoyl, aryl sulphonyl group eg benzene- or toluene sulphonyl group, 1-alkyl or aryl-1 aminomethyl-1-methyl group, or alkenyl succinyl group, eg fatty alkenyl succinyl group eg octadecenyl succinyl group.

Component (I) contains at least one alkyieneimine with an above substituent eg 0.1-1 substituent per nitrogen atom in the polyalkyleneimine chain, especially 0.5-1 per secondary nitrogen atom in the polyalkylene imine chain, and/or per primary nitrogen atom in said chain.

Component (I) may have at least one alkyleneimine unit, eg at least one repeating unit of formula —CₙH₂ₙ—N—(X)_{f}—R¹⁰ where f is 0 or 1, n is 2-5 or 2 - 4, eg 2, X is an inorganic or organic intermediate group (eg as defined above) and R¹⁰ is an organic group, eg as described for R or A above. The compounds may contain 10-100 of such units and/or —CH₂CH₂—NH— units. The compounds may have NH₂ or —NH—(X)_{f}—R¹⁰ or HO termination groups.

Component (I) may be prepared by reacting a polyalkyleneimine with a compound of formula R¹⁰—(X)_{f}—Y, wherein R¹⁰, X and f are as defined above and Y is a nucleophilic leaving group such as a halide eg chloride or bromide or hydroxy group or ester thereof, eg a sulphonate ester, such as one of 1-10 carbons eg methane-, benzene-, toluene- or xylene-sulphonate ester group. Examples of compounds of formula R¹⁰ (X)_{f}Y are acid chlorides (or the acids themselves) from lauric, palmitic, stearic, oleic acids benzoic or cinnamic acids or sulphonyl chlorides from benzene, toluene or xylene sulphonic acids, or an acid anhydride (or acid itself) such as a substituted succinic acid e.g. octadecenyl succinic anhydride, or an alkyl halide, alkyl benzyl halide or benzyl halide especially a bromide, such as lauryl, cetyl, dodecyl, stearyl, benzyl bromide and dodecyl benzyl bromide. The polyalkyleneiminie may be of a structure as described for the polyalkyleneimine back bone above; the polyalkylene imine usually has secondary or tertiary internal chain N atoms and usually primary terminal N atoms; the ratio of primary to secondary to tertiary N atoms is usually 0.5-2:1-4:0.5-2 e.g. about 1:2:1. The reaction may be performed with heating usually at 30-250° C. such as 100-200° C. and may be in the presence of a base eg an acid acceptor (for HY); examples are particulate inorganic hydroxides and carbonates, such as calcium carbonate and organic tertiary bases such as NN dimethylaniline. When the Y group is OH, the reaction may be performed with continuous removal of by product water eg azeotroping in a Dean and Stark apparatus, or by evaporation under vacuum; the latter may also be used when Y is a halide. The reaction may be performed with a molar ratio of R¹⁰(X)_{f}—Y compound to NH group in the polyalkyleneimine of 0.1-10:1. The reaction may be performed in the presence of air inert solvent or diluent eg hydrocarbon solvent such as xylene or cyclohexane. The reaction may be continued until substantially all the secondary and/or primary NH groups have been reacted.

Component (I) may also be prepared by reacting a polyalkyleneimine with an epoxide or a mixture of at least two epoxides, or an imine eg with a terminal epoxy or imine group. Examples of such epoxides or imines are those which are R substituted ethylene oxides or ethylene imines such as 1,2-epoxy octadecane, 1,2-epoxy eicosane, 1,2-epoxy docosane and mixtures thereof. The epoxide or imine may also have an internal epoxy or imine group as in epoxidised internal alkadienes or alkenes, eg octadiene or epoxidised ricinoleic acid. Apart from use of the epoxide or imine the reaction conditions, proportions etc may be as described above. The products are ones in which the organic substituent is bonded to the polyethylene imine by an intermediate group, which is a hydroxy (or amino) alkylene or alkylidene group (or a mixture thereof).

The acyl substituted polyethylene imines which are predominantly linear may also be made by cationic polymerisation of 2-alkyl oxazolines, while other N-organo substituted polyethylene imines may be made by cationic polymerisation of the corresponding N-substituted aziridines.

At the end of the reactions the products may be used as such or after working up, eg by filtration or extraction of any products from the acid acceptor, and optionally evaporation of any solvent or diluent.

The blends may comprise at least 2 different components (I). They may differ in respect of different organic substituents especially different alkyl chain lengths, different numbers of carbonatoms between the nitrogen atoms of the polyalkylene imine. Thus the organic substituents especially the alkl chain length may differ by at least 1, e.g. 1-9 such as 3-7 carbon atoms. The ratio of the weights of the 2 different components I may be 10-90:90-10 e.g. 25-75:75-25.

The oil whose flow characteristics are to be improved usually comprise a liquid hydrocarbon.

The hydrocarbon is usually primarily aliphatic in nature, but may contain up to 50% w/w liquid aromatic compounds. The hydrocarbon may be a crude or black oil or non volatile fraction from a distillation of crude oil, such as a vacuum or thermal residue. Preferably the hydrocarbon is an oil field product, e.g. either a whole well product, the multiphase mixture in or from the well bore, or one at the well head after at least partial separation of gas and/or water (and may be a condensate), and may be flowing up a well bore, or on a production platform or between platforms or from a platform to a collection or storage facility e.g. from offshore to onshore. Particularly of interest are hydrocarbons moved in pipelines under the sea under low temperature conditions e.g. in latitudes of greater than 50° N or S or in Gulf of Mexico. The hydrocarbon may contain up to 50% by weight of wax usually 0.5-30% or 1-15% especially 2-9% and the wax may contain 20-100 e.g. 20-60 or 30-60 or 40-70 carbon atoms; the hydrocarbon may contain 0.1-5% e.g. 0.2-1% of waxes of 20-60 carbons. The hydrocarbons may contain dissolved gas (e.g. with amounts of up to 10% gas) or water or water droplets e.g ,. with 5-40% water (e.g. as in water in oil emulsions, so called “chocolate mousse”). There may also be gas and/or water as a physically separate phase. The hydrocarbons may in the absence of the compounds of the invention, have a wax appearance temperature (WAT) value which approximates the cloud point value of at least 0° C. e.g. 0-60° C. or 10-50° C., 20-45° C. or 20-40° C.; pour point of such hydrocarbons may be 10-50° C. e.g. 20-50° C. lower than the WAT value and may be −30° C. to 20° C. e.g. −20° C. to +10° C. The polymers, blends and compositions of the invention may reduce the WAT value of the liquid hydrocarbon by at least 2° C. e.g. 2-20° C. such as 5-15° C., and can reduce the rate of wax deposition per unit time.

The compounds may also delay the onset of wax nucleation e.g. as shown by light scattering and they may also reduce the pour point and/or modify the wax crystals or disperse the wax. In particular the compounds may reduce the weight of wax deposition either by reducing the rate of depositionand/or by reducing the temperature of onset of deposition. The reduced wax deposition may be associated with reduced wax in suspension (i.e. reduced total wax formation) or the same or an increased amount of wax in suspension (i.e. the altering distribution of wax between suspension and deposition).

The polymers, blends and compositions may be mixed in a portion with the hydrocarbon to be protected or may be mixed batchwise, continually or continuously with a moving usually liquid body of that oil e.g. hydrocarbon, preferably added to a line containing flowing liquid hydrocarbon to be protected, upstream of a cooler location where wax deposition may occur in the absence of said compound. If desired the polymers blends and compositions may be added to a tank of the oil e.g. to inhibit deposition of wax. The amount of polymer or polymer blend added may be 10-10,000 ppm e.g. 100-5000 ppm based on the weight of oil e.g. hydrocarbon, while the weight of additive may be 1-1000 e.g. 5-100 ppm such as 20-60 ppm on the same basis; there may also be present 5-2000 ppm e.g. 30-1000 ppm (on the same basis) of long chain alcohol, e.g. of 14-40 or 15-25 carbons, such as described for use in the preparation of the ester polymer.

The amount of component (I) or component (II) present in the oil may each be 5-2000 ppm e.g. 10-500 or 20-250 such as100-1000 ppm; the ratio of component (I): component (II) may be 10-90:90-10 e.g. 25-75:75-25.

The invention is illustrated in the following Examples:

Coaxial Shearing Cell Wax Deposition test

The test apparatus comprised an internally water cooled stationary cylinder which was fitted with upper inlet and outlet tubes for coolant, and a rotatable drum coaxial with the cylinder and spaced from it by an annulus, which in this test contains the fluid to be tested. The drum, fitted with a motor, is immersed in a water bath (at about 38° C.).

In the test the drum was mounted for rotation in the bath, a thermal insulator pad laid in the bottom of the drum and the liquid to be tested poured into the drum. The cylinder was then lowered into the liquid down to the pad. The drum was rotated at 150 rpm to effect shearing in the liquid. The coolant flow was then started and the flow rate and temperatures of coolant, cylinder and drum monitored. The temperature of the cylinder was kept at a fixed temperature in the 15-20° C. region, which caused wax to be deposited on the outer surface of the cylinder. Every 6 hrs the rotation was stopped, the cylinder removed and the oil adherent to the wax removed, followed by removal of the solid wax coating which was weighed to give the weight of wax deposited in the 6 hr from which the rate of deposition was calculated and expressed as g per day.

Cold Finger Wax Deposition Test

A matrix of glass bottles (200 cm³) each containing a U shaped cold finger maintained at a constant temperature of 10.4° C. with internally circulated coolant, was housed in a thermostated cabinet maintained at a constant temperature of 35° C. The U tubes were kept vertical at a constant depth in the fluid. Each bottle contained a magnetic stirrer follower (operating at 700 rpm). Before each test the stainless steel (4.6 mm id) U tubes (Cold Fingers) were cleaned with toluene to remove any adherent organic soluble chemicals, after which they were cleaned with a fine grade emery paper then rinsed, wiped and dried. The stirrer pellets were washed in toluene and dried before use.

In each case the fluid to be tested containing the oil, with additive(s) if any, was in the bottle, the stirrer was operated and then the cold finger inserted into the fluid. After 19 hrs the U tubes were lifted out of the powder bottle, the deposit was inspected, removed, dried, and weighed. Several repeat experiments were done and the results averaged.

Tube Blocking test

The test was on the rate of build up of waxdeposits in a pipeline as evidenced by the temperature at which blockage occurs. The apparatus comprised in a stainless steel coil of 1.88 mm internal diameter tube 3.2 m long which was maintained in a constant temperature bath and the solution at 55° C. containing liquid to be tested was passed through this coil at 5 ml/min, giving a 2 minute retention time. Initially the bath was at 40° C. and then the temperature of the bath was reduced to 10° C., well below the temperature at which wax would deposit and block the tube in the absence of inhibitor. The liquid exiting the coil was recycled through a heating bath at 55° to melt any wax crystals in it and then returned to the cold coil. In this way the only solid involved in the experiment was that deposited in the coil. The pressure difference across the coil was monitored to determine the build up of deposit and the temperature for complete blockage noted; this was deemed to occur when the pressure difference across the coil was greater than 12.5 psi.

Wax Apperance Temperature (WAT) Test

The test fluid was loaded by capillary action into a flat cross-section microscope capillary tube. The contents were then sealed in place with rapid drying epoxy cement. The capillary tube was then loaded into a temperature-controlled microscope stage and the contents monitored and recorded by video. During this test the fluid was heated up to 85° C. and kept at this temperature for fifteen minutes to dissolve any crystals and ensure liquid homogeneity. The temperature was then reduced at a rate of 5° C./min down to a temperature which is about 10° C. above the WAT of the blank and then cooled at a rate of 0.1° C./min to determine accurately the WAT i.e. the highest temperature at which wax crystals deposited. The morphology of the wax crystals was also studied.

Wax Nucleation Test

In this test the property of affecting wax nucleation was tested, by the determination of the first appearance of crystals in the test solution (with wax) by light scattering. Into the test solution in a vial maintained in at a first temperature enclosure for 18 hours was passed monochromat infra-red light and the amounts of light transmitted through the vial and the scattered at 90° thereto were detected on solid state detectors and the information fed to a computer. The temperature was then lowered to a second temperature and the experiment repeated at progressively lower temperatures. The lowest temperature at which a test solution (with wax) contained in a vial will not show wax nucleation for 6 hours was noted. Each via contained 20 g of the wax solution C, together if required with appropriate amount of additive (in decane); after mixing the components at 50° C., the solutions were stored at 50° C. ready for use. The morphology of the wax crystals deposited was also studied.

Preparation of Polymers

Polymer A

A stirred solution of poly(methyl acrylate), MW 40,000, (8.6 g) and octadecanol (25.7 g) in anhydrous toluene (100 ml), with added sodium methoxide catalyst (40 mg), was heated in an oil bath at 130 C. under Dean-Stark solvent removal conditions for 7 hours. Toluene (10 ml) was removed in this manner after each 0.5 hr period and an equal amount of fresh toluene was replaced at that time. Extra sodium methoxide (40 mg) was added after 4 h, then again after a further 0.5 h. The toluene solution of product, after cooling, was used as such is a 19.5% w/w solution

Proton NMR spectroscopy indicated that the transesterification had proceeded to 64% because of a 64:36 ratio of signals from the ester alkyl hydrogens to ester methyl hydrogens. The product also contained unreacted octadecanol. The polymer can be isolated by precipitation with methanol. The polymer product had a calculated MW of 109,000.

Polymer B

The procedure to make polymer A was followed with poly(methyl acrylate) (6.88 g) and 1-docosanol (25 g). 1H NMR spectroscopy indicated a degree of transesterification of 67%. MW was calculated at 132,000 and the product was present at 31% w/w in toluene solution.

Polymer C

The procedure used to make polymer A was followed but with the one-quarter of the amounts of solvent and catalyst and using poly(methyl acrylate) (0.87 g) and 1-eicosanol (2.7 g). 1H NMR spectroscopy indicated a degree of transesterification of 85%. MW was calculated at 145,000 and the product was present at 16.8% wlw in toluene solution.

Polymer D

The procedure used to make polymer A was followed with poly(ethyl acrylate), MW 95,000, (8 g) and 1-docosanol (25 g). 1H NMR spectroscopy indicated a degree of transesterification of 99%. MW was calculated at 359,000 and the product was present at 32.6% w/w in toluene solution.

Polymer E

A solution of poly(methylacrylate), MW 40,000 (8.6 g) and hexadecanol (24.2 g) in dry toluene (100 ml) was heated in an oil bath, at 120-130° C. with stirring. Reflux was started using a Dean and Stark head and when it had been established that no water was present sodium methoxide (about 40 mg) was added to the reaction mixture. Toluene was removed from the receiver leg at 30 min. intervals and the flask replenished with fresh toluene. Fresh sodium methoxide (about 40 mg) was added aflter approximately 4 and 5 hrs. and the reaction continued for a total of 6 hrs.

Proton nmr spectroscopy showed the degree of transesterification to be 14%.

Sodium metal (0.2 g) was added to the reaction mixture and the reaction continued at very slow reflux overnight during which time the sodium dissolved. As the reaction proceeded further, toluene was added to reduce the solution viscosity in addition to solvent replacement. After a firther 5 hrs. the reaction was terminated.

Proton nmr spectroscopy showed the reaction to have gone to 74% conversion.

The product was further purified at least to remove unreacted alcohol by addition to methanol of the toluene solution to precipitate polymer as a pale yellow powder, for which a nmr spectroscopy showed the presence 1 of alkyl side chains of which 87% had 16 carbons and 13% had 1 carbon.

In the case of each of Polymer A-C, the polymer was used in the tests mixed with its unreacted alcohol.

Polymer F

The process to make Polymer A was repeated with the 40,000 Molec. Wt polymethyl acrylate and a mixture of alcohols sold by Condea under the Trade Mark NAFOL 2022, which was a mix of 7% C₁₈, 58% C₂₀, 30% C₂₂ and 6% C₂₄ alkanols and use of an equivalent amount of a different catalyst namely titanium tetra isopropoxide. The transesterificatidn reaction proceeded to 78% conversion, as determined by analysis on the product. The calculated Mw of the product was 141220. The unreacted alcohol was not separated, and the product was used in 31.9% solution intoluene.

Polymer G

The procedure to make polymer A was followed with poly(ethyl acrylate) (8.66 g) of MW 95,000 and 1-octadecanol (22.2 g) 1H NMR spectroscopy indicated a degree of transesterification of 90%. MW was calculated at 290,000 and the product was present at 28.9% w/w in toluene solution.

Polymer H

The procedure to make polymer A was followed with poly(ethyl acrylate) (10.0 g) of MW 95,000 and 1-octadecanol (25.7 g). 1H NMR spectroscopy indicated a degree of transesterification of 40%. MW was calculated at 180,000 and the product was present at 21.5% wlw in toluene solution.

Preparation of Polymer I

A stirred solution of poly(methyl acrylate), MW 8,000 (8.82 g), Mw/Mn of 1.6 and 1-eicosanol (27.07 g) in anhydrous toluene (100 ml), with added sodium methoxide catalyst (40 mg), was heated in an oil bath at 130° C. under Dean-Stark solvent removal conditions for 6 hours. Toluene (10 ml) was removed in this manner after each 0.5 hr period and an equal amount of fresh toluene was replaced at that time. Extra sodium methoxide (40 mg) was added after 2 h, then again after a further 2 h. The toluene was then removed in vacuo

Proton NMK spectroscopy indicated that the transesterification had proceeded to 61% because of a 61:39 ratio of signals from the ester alkyl (CH2) hydrogens to ester methyl hydrogens. The product also contained unreacted 1-eicosanol. The polymer product had a calculated MW of 23,000.

Preparation of Polymer J

The procedure to make polymer 1 was followed with the same poly(methyl acrylate) (8.6 g) but reacted with 1-docosanol (29.3 g). 1H NMk spectroscopy indicated a degree of transesterification of 74%. The toluene was removed in vacuo and the MW of the product was calculated at 28,000.

Preparation of Polymer K

A stirred solution of poly(methyl acrylate), MW 40,000 (as determined by GPC against standard methods), (5.31 g), and a mixture of alcohols with 85% oleyl alcohol (74% cis isomer, 10% trans isomer, 13% linoleyl alcohol (cis, cis isomer), 3% conjugated species) and 15% of saturated alcohols of 14-18 carbons ( 6.44 g) in anhydrous toluene (70 ml), with added sodium methoxide catalyst (100 mg), was heated in an oil bath at 130° C. under Dean-Stark solvent removal conditions for 3 hours. Toluene (10 ml) was removed in this manner after each 0.5 hr period and an equal amount of fresh toluene was replaced at that time. Extra sodium methoxide (100 mg) was added after 1.5 hr. The toluene was then removed in vacuo

Proton NMR spectroscopy indicated that the transesterification had proceeded to 60% beeause of a 60:40 ratio of signals from the ester alkyl (CH2) hydrogens to ester methyl hydrogens. The product also contained unreacted oleyl alcohol. The polymer product had a calculated NfW of 105,920.

Preparation of Polymer L

A stirred solution of poly(methyl acrviate), MW 40,000, (as determined by GPC against standard methods),(8.6 g) and octadecanol (25.7 g) in anhydrous toluene (100 ml), with added sodium methoxide catalyst (40 mg), was heated in an oil bath at 130° C. under Dean-Stark solvent removal conditions for 7 hours. Toluene (10 ml) was removed in this manner after each 0.5 hr period and an equal amount of fresh toluene was replaced at that time. Extra sodium methoxide (40 mg) was added after 4 h, then again after a further 0.5 h. The toluene solution of product, after cooling, was used as such is a 19.5% w/w solution

Proton No spectroscopy indicated that the transesterification had proceeded to 63% because of a 63:37 ratio of signals from the ester alkyl hydrogens to ester methyl hydrogens. The product also contained unreacted octadecanol. The polymer can be isolated by precipitation with methanol. The polymer product had a calculated MW of 109,800.

Preparation of Polymer M

A polyethyleneimine of molecular weight 1800 (obtained from Polysciences Limited and believed to have a linear and branched structure) (4.3 g) was heated with stirring under nitrogen with 1,2-epoxyoctadecane (26.8 g about an equivalent of epoxy per N atom in the polyalkylene imine) for 16 hrs at 180° C. The reaction product was allowed to cool.

The product accorded with a structure formed from addition of an NH group in the polyethyleneimine to the epoxy ring.

Polymer N

A copolymer of methyl acrylate and octadecylacrylate was made by copolymerisation in an organic solvent in the presence of a peroxide catalyst. At the end of the reaction, unreacted acrylate monomers were evaporated to leave a copolymer, which nmr showed contained methyl and octadecyl groups (and hence the corresponding acrylate ester structural units) in a molar ratio of 40:60. The Molecular weight (Mw) of the copolymer was 78000 “calculated” and 48000 (GPC).

AG. Poly octadecyl acrylate Wt Average Molecular Wt 35,000.

AH. Polyvinyl stearate Wt Average Molecular Wt 19,000.

Additive

AJ. N-2-aminoethyl-2-oleyl imidazoline (sold as IC107 by BP Chemicals)

AK. n-oleylamine

AL. n-octadecylamine

AM. Mono/N-tallyl-1,3-propylene diamine

AN. Mono N-tallyl-1,3-propylene diamine polyethoxylate with an average of 4.5 ethylene oxy units per molecule.

Oils

1. A black crude North Sea Oil with wax content of about 6% by weight, wax appearance temperature of 35° C., pour point of 0° C., Cloud Pt. 35° C.

2. A black crude oil from West of Shetland, Scotland with an API value of 36, a wax content of 9% wt, a wax appearance temperature and cloud point of about 38° C., and a pour point of −9° C.

3. An oil consisting of 5% of wax (58/60 refinery fraction) 5% toluene and 90% decane fraction, all by weight. The oil had a wax appearance temperature (Cloud Pt) of 17.6° C.

4. An oil consisting of 5% of wax (150/155 refinery fraction) 5% toluene and 90% decane fraction, all by weight. The oil had a WAT (Cloud Pt) of 30.3° C.

5. An oil consisting of 10% of the wax of oil 3 with 5% toluene and 85% decane fractions (by weight). Its WAT (Cloud Pt) was 24.3° C.

6. An oil consisting of 10% of the wax of oil 4 with 5% toluene and 85% decane fractions (by weight). Its WAT (Cloud Pt) was 34.9° C.

7. A crude oil from the Gulf of Mexico containing 4% by weight of wax and of API Gravity 33, Cloud Point 35° C. (95° F.), Pour Point −21° C. ( −6° F.) (according to IP 15), WAT 34.5° C.

8. A HPHT condensate oil from North Sea well containing 15% (wt) wax, of API gravity about 50-60 and with a WAT of 49° C. (120° F.) and Pour Pt. Of 10° C. (50° F.).

9. A black crude oil from West of Shetland, Scotland containing 12.5% (wt) wax and with a WAT of 39° C. and Pour Pt. of 9° C.

### EXAMPLE 1

A series of blends were made by mixing the polymer and/or another polymer and/or additive AJ, and the appropriate oil. The natures and amounts of the polymers or additive expressed as ppm in the total oil were as given in Table 1. The oil containing the blends was then tested in the Coaxial Shearing Cell Wax Deposition Test with 14° C. of subcooling below the WAT; and the results were as given below.

Oil 1 - No additive

| | | | Wt wax |
|---|---|---|---|
| Polymer | | Cold Plate | deposited/ |
| Nature | Amount ppm | Temp ° C. | g day |
| A | 800 | 20.2 | 5.00 |
| B | 800 | 20.5 | 2.87 |
| C | 800 | 20.3 | 0.8 |
| D | 800 | 20.4 | 2.68 |
| Commercial 1 | 800 | 20.5 | 4.45 |
| Commercial 2 | 800 | 20.8 | 5.77 |
| Blank | 0 | 20.7 | 7.32 |

Commercial 1 and commercial 2 polymers were available as flow improvers.

The wax was easy to remove with polymers B, C, D and the blank, had a microcrystalline structure for polymers B and Commercial 2, was sticky and difficult to remove with commercial 1 and polymer A, and was granular for the blank.

| Polymer | | Polymer | | Additive | Cold | Wax |
|---|---|---|---|---|---|---|
| | Amount | | Amount | Amount | Plate | Dep, |
| Nature | ppm | Nature | ppm | ppm | Temp. ° C. | g/dy |
| Oil 2 | | | | | | |
| B | 120 | C | 60 | 20 | 15.83 | 0.147 |
| A | 90 | B | 90 | 20 | 15.25 | 0.309 |
| B | 180 | 0 | 0 | 20 | 15.57 | 0.410 |
| B | 60 | C | 120 | 20 | 15.09 | 0.860 |
| B | 200 | 0 | 0 | 0 | 15.64 | 0.893 |
| A | 200 | 0 | 0 | 0 | 15.33 | 1.34 |
| C | 90 | B | 90 | 20 | 15.10 | 1.70 |
| C | 90 | A | 90 | 20 | 15.23 | 2.13 |
| Blank | 0 | 0 | 0 | 0 | 14.55 | 3.98 |
| Oil 4 | | | | | | |
| C^{x} | 400 | E | 400 | 40 | 20.0 | 0.77 |
| C^{x} | 400 | E | 400 | 0 | 20.0 | 3.02 |
| C | 800 | 0 | 0 | 0 | 20.0 | 5.76 |
| Commer- | 800 | 0 | 0 | 0 | 20.0 | 6.75 |
| cial 2 | | | | | | |
| C | 800 | 0 | 0 | 40 | 20.0 | 6.81 |
| Blank | 0 | 0 | 0 | 0 | 20.3 | 72.09 |

C^{x} is a repeat preparation of C.

### EXAMPLE 2

Polymers were tested at 800 ppm in Oil 1 in the Tube Blocking test. The results were as follows.

| | Temperature of Coil | Suppression of |
|---|---|---|
| Polymer | Blocking ° C. | Blocking temp ° C. |
| C | 7.1 | 23.7 |
| Commercial 1 | 20.2 | 14.2 |
| Commercial 2 | 20.3 | 14.1 |
| B | 22.4 | 12.0 |
| None | 24.3 | 10.1 |

In the case of the oil with no polymer, blocking started after 70 mins, while in the case of oil in the polymer C there was no blocking at 20° C. after 72 hours.

### EXAMPLE 3

The effect on oil 3 of the absence or presence of various polymers and/or additive AJ was tested in the cold finger test.

| | | | | Additive | |
|---|---|---|---|---|---|
| Polymer | | Polymer | | AJ | |
| | Amount | | Amount | Amount | Wt Wax |
| Nature | ppm | Nature | ppm | ppm | deposited g |
| A | 400 | 0 | 0 | 0 | 0.143 |
| AG | 400 | 0 | 0 | 0 | 0.558 |
| A | 400 | 0 | 0 | 40 | 0.044 |
| AG | 400 | 0 | 0 | 40 | 0.235 |
| A | 200 | E | 200 | 40 | Negligible |
| AG | 200 | E | 200 | 40 | Negligible |
| | 0 | 0 | 0 | 40 | 0.990 |
| Blank | 0 | 0 | 0 | 0 | 0.878 |
| A | 400 | 0 | 0 | 40 | 0.044 |
| A | 400 | 0 | 0 | 0 | 0.143 |
| AH | 400 | 0 | 0 | 40 | 0.511 |
| AH | 400 | 0 | 0 | 0 | 0.575 |
| Blank | 0 | 0 | 0 | 0 | 0.834 |
| | 0 | 0 | 0 | 40 | 1.002 |

In the 10° C. finger work the wax deposited from oil containing the additive was soft and was easily separated, whereas with the polymer but no additive it was hard and difficult to remove. In the absence of both additive and polymer the wax was usually hard but easy to remove.

### EXAMPLE 4

The cold finger test above was used with Oil 3 containing various polymers and/or various additives in various levels.

| Polymer ppm | Additive ppm | Mass of Wax g |
|---|---|---|
| AG 400 | — | 0.549 |
| — | AJ (40) | 1.002 |
| AG 400 | AJ (40) | 0.174 |
| AG 400 | AK (40) | 0.421 |
| AG 400 | AL (40) | 0.475 |
| — | AK (40) | 0.700 |
| AG 400 | AM (120) | 0.056 |
| Blank | — | 0.834 |
| AG 400 | AN (120) | 0.034 |
| I 400 | — | 0.686 |
| J 400 | — | 0.630 |
| Blank O | — | 0779 |
| K 400 | — | 0.086 |
| Blank O | — | 0.843 |

### EXAMPLE 5

To Oil 5 were added various polymers and the wax appearance test (WAT) performed on the oil formulation obtained. The results were as follows, including both the measured WAT and the suppression of the WAT compared to the blank.

| Polymer | | Polymer | | | |
|---|---|---|---|---|---|
| | Amount | | Amount | | |
| Nature | ppm | Nature | ppm | WAT ° C. | Suppression |
| Blank | — | — | — | 24.3 | — |
| E | 200 | C | 200 | 21.7 | 2.6 |
| E | 200 | A | 200 | 22.1 | 2.2 |
| B | 200 | C | 200 | 22.2 | 2.1 |
| B | 200 | B | 200 | 22.3 | 2.0 |
| E | 400 | — | — | 22.6 | 1.7 |
| A | 200 | C | 200 | 21.7 | 2.6 |
| E | 400 | A | 400 | 21.2 | 3.1 |
| A | 400 | C | 400 | 20.9 | 3.4 |
| B | 400 | C | 400 | 21.6 | 2.7 |
| E | 400 | AG | 400 | 21.8 | 2.5 |
| E | 400 | C | 400 | 21.1 | 3.4 |
| I | 400 | — | — | 21.3 | 3.0 |
| J | 400 | — | — | 21.9 | 2.4 |
| K | 400 | — | — | 23.2 | 1.1 |

A formulation containing Oil 5 with 267 ppm Polymer E, 267 ppm Polymer C and 267 ppm Polymer B had a WAT of 21.5° C. i.e. Suppression 2.8° C.

### EXAMPLE 6

To Oil 6 were added various polymers and/or additive (AJ) and the WAT test performed on the oil formulation obtained. The results were as follows, including the measured WAT and the suppression of WAT compared to the blank.

| Polymer | | Polymer | | Additive | | |
|---|---|---|---|---|---|---|
| | Amount | | Amount | Amount | WAT | Suppression |
| Nature | ppm | Nature | ppm | ppm | ° C. | ° C. |
| Oil 2 | | | | | | |
| — | — | — | — | — | 34.9 | — |
| C | 200 | A | 200 | 40 | 31.6 | 3.3 |
| C | 200 | B | 200 | — | 30.9 | 4.0 |
| C | 200 | E | 200 | — | 31.9 | 3.0 |
| C | 400 | B | 400 | — | 30.5 | 4.4 |
| C | 400 | A | 400 | — | 31.1 | 3.8 |
| B | 400 | E | 400 | — | 31.1 | 3.8 |
| C | 400 | E | 400 | — | 31.2 | 3.7 |
| C | 400 | E | 400 | 40 | 31.2 | 3.7 |
| C | 400 | A | 400 | 40 | 31.1 | 3.8 |

A formulation of Oil 6 with 267 ppm Polymer E, 267 ppm polymer C and 267 ppm Polymer B had a WAT of 30.3° C.

### EXAMPLE 7

To Oil 2 were added various polymers and/or additive (AJ) and the WAT test performed in the oil formulation obtained. The results were as follows.

| Polymer | | Polymer | | | |
|---|---|---|---|---|---|
| | | Amount | | | Amount |
| Nature | ppm | Nature | ppm | Additive | WAT ° C. |
| Blank | — | — | — | — | 38.0 |
| B | 90 | C | 90 | 20 | 31.1 |
| A | 90 | C | 90 | 20 | 34.1 |
| B | 60 | C | 120 | 20 | 34.8 |

### EXAMPLE 8

The coaxial shear test was performed on the Oil 2 with the Polymer F in amount of 180 ppm, and Additive AJ in amount of 20 ppm. The WAT was 35.2° C., a depression of 2.8° C. on the blank results with Oil 2. The coaxial shear test was performed for 330 min, with a cold plate average temperature of 15.7° C., an oil bath temperature of 29.2° C. and a coolant temperature of 5.90° C. The weight of wax deposited was 0.0563 g, corresponding to an amount per day of 0.246 g, (compared to 3.98 g from a cold plate temperature of 14.55° C. for Oil 2 without the Polymer). The wax deposit was soft, smoth and easily removed.

### EXAMPLE 9

The coaxial shear test was performed on the Oil 2 with the Polymer F in amount of 800 ppm. The WAT was 35.6° C., a depression of 2.4° C. on the blank results with Oil 2. The coaxial shear test was performed for 290 min, with a cold plate average temperature of 19.6° C., an oil bath temperature of 30.0° C. and a coolant temperature of 7.94° C. The weight of wax deposited was 0.0910 g, corresponding to an amount per day of 0.452 g, (compared to 3.98 g from a cold plate temperature of 14.55° C. for Oil 2 without the Polymer). The wax deposit was of small irregular shaped plates.

### EXAMPLE 10

The Coaxial Shear test was performed on Oil 4 with the Polymer F in amount of 800 ppm. The WAT was 24.2° C., a depression of 6.1° C. on the blank results with Oil 4. The Coaxial test was performed for 290 min, with cold plate average temperature of 20.0° C. an oil bath temperatures of 38° C. and a coolent temperature of 13.0° C. The weight of wax deposited per day was 11.14 g/day compared to 72.09 g/day with cold plate temperature of 20.3° C. with Oil 4 and no Polymer F.

### EXAMPLE 11

In this Example, the effectiveness of the inhibitor blends of the invention in affecting wax formation or deposition was compared in the wax nucleation test to a blank with no inhibitor blend added. The tests were performed on a wax test solution C of the following weight composition.

5% crystals of wax (Ref. 58/60 refinery fraction), 5% toluene and 90% decane fraction. In each case the inhibitor solutions were made up in 1% w/w solution in decane and appropriate amounts added to provide total concentrations of 400 ppm or 800 ppm in the test solution with the wax. The results were as follows:

| Blend | Amount of each | Total amount | Average Nucleation |
|---|---|---|---|
| Components | component ppm | ppm | Onset Temperature ° C. |
| M + AG + C | 267 | 800 | 14.2 |
| M + G + C | 267 | 800 | 14.2 |
| M + G | 400 | 800 | 14.3 |
| M + A + C | 267 | 800 | 14.3 |
| M + H | 400 | 800 | 14.5 |
| M + C | 400 | 800 | 14.5 |
| M + A | 400 | 800 | 14.6 |
| M + AG | 400 | 800 | 14.6 |
| Blank | — | — | 18.5 |
| M + G | 200 | 400 | 14.7 |
| M + AG | 200 | 400 | 15.1 |
| M + A | 200 | 400 | 15.3 |
| M + H | 200 | 400 | 15.3 |
| M + G | 200 | 400 | 15.4 |
| M | 400 | 400 | 15.8 |
| Blank | — | — | 18.5 |

The morphology of the wax crystals deposited in each instance (except in the case of the blanks) was a powder. Angular crystals were deposited in the blank runs.

### EXAMPLE 12

A blend was made by mixing polymer K and polymer L in oil 7. The amounts of the polymers expressed as ppm in the total oil are given below. The oil containing the blend was then tested according to the cold finger test procedure described above except that the cold finger temperature was maintained at 5.0° C. and the stirrer operated at 300 rpm. The results are given in below.

| Polymer | | Polymer | | Wt Wax |
|---|---|---|---|---|
| Nature | Amount ppm | Nature | Amount ppm | deposited g |
| K | 200 | L | 100 | 0.206 |
| Blank | 0 | 0 | 0 | 0.592 |

### EXAMPLE 13

The preparation for polymer L was repeated with octadecanol and different weights of sodium methoxide catalyst to give products Polymers B1- 12 having different degrees of transesterification. In each case the polymer product was tested in oil 3 at 400 ppm for WAT and for the mass of wax deposited in the cold finger test. The results were as follows:

| Polymer | % Conversion | WAT ° C. | Mass Wax Deposited |
|---|---|---|---|
| B1 | 4 | 22.9 | 0.754 |
| B2 | 14 | 22.2 | 0.518 |
| B3 | 17 | 22.3 | 0.470 |
| B4 | 24 | 22.4 | 0.394 |
| B5 | 29 | 22.5 | 0.284 |
| B6 | 40 | 21.9 | — |
| B7 | 43 | 21.8 | 0.139 |
| B8^{x} | 47 | 21.0^{x} | 0.201 |
| B9 | 60 | 21.3 | 0.044 |
| B10 | 69 | 21.4 | 0.209 |
| B11 | 89 | 21.4 | 0.163 |
| B12^{x} | 89 | 21.1^{x} | — |
| AG | [100] | 21.9 | 0.550 |
| Polymethyl | 0 | 23.7 | |
| acrylate | | | |

Polymers B8^{x} and B12^{x} were purified by solution of the product and precipitation of the polymer for recovery and use, leaving the unreacted fatty alcohol and possibly low molecular weight polymer in the solution.

### EXAMPLE 14

The preparation for polymer L was repeated with docosanol and different amounts ofodium methoxide catalyst to give product polymers D1-5 having different degrees of transesterification. In each case the polymer product was tested in oil 4 at 400 ppm for WAT.

| Polymer | % Conversion | WAT ° C. |
|---|---|---|
| D1 | 11 | 34.0 |
| D2 | 29 | 31.0 |
| D3 | 34 | 30.7 |
| D4 | 64 | 30.7 |
| D4^{x} | 64 | 30.3 |
| D5 | 91 | 31.4 |

Polymer D4 was purified by solution, and then precipitation of polymer.

### EXAMPLE 15

A fresh batch of Polymer L (called polymer B 13) was prepared to give a product with 68% conversion and calculated Molec Wt of 115440 (Mw/Mn 2.6). This product was compared with polymer N at 400 ppm in oil 3. The WAT results were as follows. Polymer B13, 21.8° C., Polymer N 22.1° C., Blank 24.3° C. The cold finger 10° C. results were Polymer B13 0.377 g, Polymer N 0.139 g, Blank 0.779 g.

### EXAMPLE 16

A fresh batch of Polymer L (called polymer B14) was prepared to give a product with 69% conversion. This and polymer N were tested in Oil 3 in the cold finger test 10° C. and compared to the same polymer oil blend mixed also with 40 ppm of Additive AJ. The results were as follows.

| | | | |
|---|---|---|---|
| Polymer | ppm | Addition ppm | Wax Deposited |

| | | | |
|---|---|---|---|
| B14 | 200 | 0 | 0.430 |
| B14 | 200 | 40 | 0.088 |
| B14 | 400 | 0 | 0.233 |
| B14 | 400 | 40 | 0.005 |
| Blank | 0 | 0 | 0.720 |
| N | 400 | 0 | 0.210 |
| N | 400 | 40 | 0.004 |

### EXAMPLE 17

The cold finger test was applied to oil 7 containing 250 ppm polymer N and 50 ppm additive AJ. The results were as follows: blend 0.176 g, blank 0.53 g.

### EXAMPLE 18

Various blends were tested in oil 8 in the cold finger test with stirrer at 700 rpm, cold finger at 17.5° C. and oven at 28.0° C. The results were as follows.

| Polymer | (Amt ppm) | Polymer | (Amt ppm) | Additive | (ppm) | Mass of Wax g |
|---|---|---|---|---|---|---|
| B11 | 260 | D4 | 130 | AJ | 100 | 0.209 |
| C1 | 260 | B9 | 130 | AJ | 100 | 0.266 |
| C2 | 130 | E1 | 260 | AJ | 100 | 0.277 |
| B11 | 130 | D4 | 260 | AJ | 100 | 0.291 |
| C1 | 130 | B9 | 260 | AJ | 100 | 0.293 |
| B9 | 400 | 0 | 0 | AJ | 100 | 0.366 |
| Blank | 0 | 0 | 0 | 0 | 0 | 0.639 |

Polymers C1, C2, D4 and E1 were made according to the general procedure for Polymer L but with alcohol and % conversion as follows; C1 eicosanol 68% C2 eicosanol 81%, D4 docosanol 64% and E1 tetra cosanol 66%. For C1 the catalyst was the one used for polymer F.

### EXAMPLE 19

A fresh batch of Polymer L (hereafter polymer B15) was made with 63% conversion. Various polymers and blends were tested in oil 9 in the cold finger test with stirrer at 300 rpm, cold finger temperature 17° C. and oven at 35° C. The results were as follows:

| Polymer | ppm | Polymer ppm | Additive | ppm | Total ppm | Wax g |
|---|---|---|---|---|---|---|
| B15 | 200 | — | AJ | 30 | 230 | 0.113 |

| | | | | | |
|---|---|---|---|---|---|
| B15 | 200 | — | — | 200 | 0.139 |
| B15 | 300 | — | — | 300 | 0.143 |

### EXAMPLE 20

Various C₂₀ chain length polymers and blends were tested in oil 1 in the cold finger test with the finger at 17° C. and the oven at 35° C. Some of the polymers (hereinafter C2-4 and D6) were prepared by the general procedure for that of polymer L but applied to 1-eicosonol (or docosanol) and use of different amounts of catalyst to give different degrees of conversion.

| Polymer | ppm | Polymer | ppm | Additive ppm | Wax g |
|---|---|---|---|---|---|
| C3 | 266 | D6 | 133 | — | 0.063 |

| | | | | |
|---|---|---|---|---|
| C3 | 400 | 0 | AJ 40 | 0.073 |
| C3 | 400 | 0 | 0 | 0.089 |
| C2 | 400 | 0 | 0 | 0.104 |
| C4 | 400 | 0 | 0 | 0.156 |
| C3 | 200 | 0 | AJ 40 | 0.178 |
| Blank | 0 | 0 | 0 | 0.232 |

Polymers C3, C2, C4 were based on eicosanol with 79%, 81% and 65% conversion. Polymer D6 was based on docosanol with 65% conversion.

### EXAMPLE 21

Various polymers were tested in oil 7 for WAT The polymers were polymer C1 and D7 which at 400 ppm gave WAT results of 31.1° C. and 31.8° C. respectively compared to a blank of 34.5° C.

Various polymers and blends were tested in oil 7 for wax deposition with cold finger at 5° C. and oven at 35° C. and stirrer speed at 300 rpm. The results were as follows.

| Polymer | ppm | Polymer | ppm | Additive ppm | Wax deposit g |
|---|---|---|---|---|---|
| B15 | 400 | 0 | 0 | 0 | 0.087 |
| B15 | 300 | 0 | 0 | 0 | 0.131 |
| B15 | 250 | 0 | 0 | AJ 50 | 0.186 |
| B15 | 200 | K | 100 | 0 | 0.206 |
| B15 | 200 | 0 | 0 | AJ 50 | 0.224 |
| B15 | 200 | Cl | 100 | 0 | 0.263 |
| Blank | 0 | 0 | 0 | 0 | 0.592 |

In a cold finger test with the finger at 15° C., the results were as follows:

| Polymer | ppm | Polymer | ppm | Additive ppm | Wax deposit g |
|---|---|---|---|---|---|
| B15 | 300 | D8 | 100 | 0 | 0.074 |
| B15 | 300 | C1 | 100 | 0 | 0.103 |
| B15 | 400 | 0 | 0 | 0 | 0.158 |
| Blank | | | | | 0.225 |

Polymer D7 and D8 were repeats of the process to make polymer L with docosanol to 64% and 82% conversion, respectively (and D8 used the catalyst for polymer F).

We claim:

1. A polymer of a monomer with structural units derived from at least one ester (i) of an aliphatic carboxylic acid with an aliphatic alcohol, wherein one of the acid and alcohol is ethylenically unsaturated and the other of the acid and alcohol has a long chain group of 14-40 carbons, and a monomer with structural units derived from a corresponding ester (3) with structural units derived from an aliphatic carboxylic acid and an aliphatic alcohol, wherein one of the acid and alcohol is ethylenically unsaturated and the other has an aliphatic group of 1-13 carbons, such that at least 50% of the said aliphatic groups have 15-35 carbons, and if the polymer contains structural units from esters from a long chain unsaturated alcohol group or from esters from methacrylic acid, then the molecular weight of the polymer is at least 40000.

2. A polymer of monomers with structural units derived from at least one ester (1) and at least one ester (3) as defined in claim 1, and at least 30% of the aliphatic groups are saturated with 15-35 carbons, and if the ester is from a long chain saturated alcohol then said polymer consists essentially of structural units of ester 1 and 3 and at least 40% of the aliphatic groups are saturated with 15-35 carbons, and if the polymer contains structural groups from esters from methacrylic acid, the molecular weight of the polymers is at least 40000.

3. A polymer of monomers with structural units derived from at least one ester (1) and at least one ester (3) as defined in claim 1, and at least 30% of the aliphatic groups are unsaturated with 15-35 carbons and if the ester 1 is from a long chain unsaturated alcohol then at least 50% of the aliphatic groups are unsaturated groups of 15-35 carbons and the molecular weight is at least 5000.

4. A polymer according to claim 1 which consists essentially of structural units derived from esters 1 and 3.

5. A copolymer according to claim 1 which is obtainable by or obtained by transesterification of at least one polymer of ester 3 with an aliphatic alcohol or carboxylic acid with an aliphatic 15-35 carbon atom group (depending on whether the acid or alcohol in ester 1 is unsaturated or aliphatic).

6. A copolymer according to claim 2 which is obtainable by or obtained by transesterification of at least one polymer of ester 3 with an aliphatic alcohol or carboxylic acid with an aliphatic 15-35 carbon atom group (depending on whether the acid or alcohol in ester 1 is unsaturated or aliphatic).

7. A copolymer according to claim 3 which is obtainable by or obtained by transesterification of at least one polymer of ester 3 with an aliphatic alcohol or carboxylic acid with an aliphatic 15-35 carbon atom group (depending on whether the acid or alcohol in ester 1 is unsaturated or aliphatic).

8. A copolymer according to claim 1 which comprises 50-90% of units from ester (1) and 10-50% of units from ester (3).

9. A copolymer according to claim 2 which comprises 50-90% of units from ester (1) and 10-50% of units from ester (3).

10. A copolymer according to claim 3 which comprises 50-90% of units from ester (1) and 10-50% of units from ester (3).

11. A copolymer according to claim 1 wherein said ester (1) has a unimodal distribution of carbon atom numbers in said long chain groups.

12. A copolymer according to claim 1 wherein the average carbon chain length of the aliphatic side chains is 11-18.

13. A copolymer according to claim 2 wherein the average carbon chain length of the aliphatic side chains is 11-18.

14. A copolymer according to claim 3 wherein the average carbon chain length of the aliphatic side chains is 11-18.

15. A copolymer according to claim 1 wherein said esters 1 and 3 are derived from an ethylenically unsaturated acid of 3-6 carbon atoms and an aliphatic alcohol.

16. A copolymer according to claim 15 wherein said acid is acrylic acid.

17. A copolymer according to claim 1 which has 10-50% structural units derived from an ester 3 of an ethylenically unsaturated carboxylic acid of 3-6 carbons and an alcohol of 1-4 carbons, and 50-90% of structural units derived from an ester 1 of an ethylenically unsaturated carboxylic acid of 3-6 carbons and an alcohol of 18-24 carbons.

18. A copolymer according to claim 5 having structural units consisting essentially of 10-50% of methyl or ethyl acrylate and 50-90% of an acrylate ester of an alcohol of 16-24 carbons.

19. A method of preparation of a copolymer which is a polymer of a monomer with structural units derived from at least one ester (i) of an aliphatic carboxylic acid with an aliphatic alcohol, wherein one of the acid and alcohol is ethylenically unsaturated and the other of the acid and alcohol has a long chain group of 14-40 carbons, and a monomer with structural units derived from a corresponding ester (3) with structural units derived from an aliphatic carboxylic acid and an aliphatic alcohol, wherein one of the acid and alcohol is ethylenically unsaturated and the other has an aliphatic group of 1-13 carbons, such that at least 50% of the said aliphatic groups have 15-35 carbons, and if the polymer contains structural units from esters from a long chain unsaturated alcohol group or from esters from methacrylic acid, then the molecular weight of the polymer is at least 40000, which comprises transesterifying at least one polymer of ester 3 with an aliphatic alcohol or carboxylic acid with a 15-35 carbon atom group (depending on whether the acid or alcohol in ester 1 is unsaturated or aliphatic).

20. A method of preparation of a copolymer which is a polymer of monomers with structural units derived from at least one ester (1) and at least one ester (3) as defined in claim 1, and at least 30% of the aliphatic groups are saturated with 15-35 carbons, and if the ester is from a long chain saturated alcohol then said polymer consists essentially of structural units of ester 1 and 3 and at least 40% of the aliphatic groups are saturated with 15-35 carbons, and if the polymer contains structural groups from esters from methacrylic acid, the molecular weight of the polymers is at least 40000, which comprises transesterifying at least one polymer of ester 3 with an aliphatic alcohol or carboxylic acid with a 15-35 carbon atom group (depending on whether the acid or alcohol in ester 1 is unsaturated or aliphatic).

21. A method of preparation of a copolymer which is a polymer of monomers with structural units derived from at least one ester (1) and at least one ester (3) as defined in claim 1, and at least 30% of the aliphatic groups are unsaturated with 15-35 carbons and if the ester 1 is from a long chain unsaturated alcohol then at least 50% of the aliphatic groups are unsaturated groups of 15-35 carbons and the molecular weight is at least 5000, which comprises transesterifying at least one polymer of ester 3 with an aliphatic alcohol or carboxylic acid with a 15-35 carbon atom group (depending on whether the acid or alcohol in ester 1 is unsaturated or aliphatic).

22. A method according to claim 19 which comprises transesterifying said polymer consisting essentially of structural units of ester 3.

23. A blend of at least 2 components selected from
group (i) homopolymers (A) with structural units derived from an ester (1) of an aliphatic carboxylic acid with an aliphatic alcohol, wherein one of the acid and alcohol is ethylenically unsaturated and the other of the acid and alcohol has a long chain group of 14-40 carbons,
group (ii) copolymers (B) thereof with structural units derived from a different ester (2) within the same definition as ester 1, such that the mole average carbon content of the long chain group is 15-35 or that at least 30% of the long chain groups have 15-35 carbons preferably 16.5-24 especially 18-22 carbons
group (iii) copolymers (C) of said ester (1) and optionally ester (2) with a corresponding ester (3) with structural units derived from an aliphatic carboxylic acid and an aliphatic alcohol, wherein one of the acid and alcohol is ethylenically unsaturated and the other has an aliphatic group of 1-13 carbons, such that at least 30% of the said aliphatic groups have 15-35 carbons, and
group (iv) monomeric additives, which have an aliphatic group of at least 14 carbon atoms and a polar group,
group (v) at least one N-substituted polyalkylene imine compound with chain nitrogen atoms, which has at least one organic substituent of at least 6 carbon atoms on at least one nitrogen atom,
with the proviso that the blend contains at least one of (i)-(iii) and (v), and, unless the blend contains a copolymer (iii), then the blend contains at least one component from more than one group, and with the proviso that when the blend is of a homopolymer (i) from an ester from an ethylenically unsaturated carboxylic acid and a saturated aliphatic alcohol, and a copolymer (iii) from esters from an ethylenically unsaturated acid and a saturated aliphatic alcohol, then the molecular weight of copolymer (iii) is at least 40000.

24. A blend according to claim 23 which contains polymers from at least two of (i)-(iii) or at least two from (iii).

25. A blend according to claim 23 which contains at least one copolymer C and at least one of components (i)-(iii).

26. A blend according to claim 23 wherein copolymer C consists essentially of structural units derived from an ester 1 and ester 3.

27. A blend according to claim 23 wherein copolymer C is obtainable by or obtained by transesterification of at least one polymer of ester 3 with an aliphatic alcohol or carboxylic acid with a 15-35 carbon atom group (depending on whether the acid or alcohol in ester 1 is unsaturated or aliphatic).

28. A blend according to claim 23 wherein copolymer C comprises 40-90% of units from ester (1) and 10-60% of units from ester (3).

29. A blend according to claim 23 wherein in copolymer C said ester (1) has a unimodal distribution of carbon atom numbers in said long chain groups.

30. A blend according to claim 23 wherein the average carbon chain length of the aliphatic side chains in copolymer C is 11-18.

31. A blend according to claim 23 wherein said esters 1 and 3 are derived from an ethylenically unsaturated acid of 3-6 carbon atoms and at least one long chain aliphatic alcohol.

32. A blend according to claim 31 wherein said aliphatic alcohol has 16, 18, 20, 22 or 24 carbon atoms, or a unimodal mixture thereof.

33. A blend according to claim 31 wherein said acid is acrylic acid.

34. A blend according to claim 23 wherein copolymer C has 10-70% structural units derived from an ester 3 of an ethylenically unsaturated carboxylic acid of 3-6 carbons and an alcohol of 1-4 carbons, and 30-90% of structural units derived from an ester 1 of an ethylenically unsaturated carboxylic acid of 3-6 carbons and an alcohol of 16-24 carbons.

35. A blend according to claim 34 wherein the molecular weight of copolymer C is at least 40000.

36. A blend according to claim 23 which comprises polymer C and at least one of polymer A and a different polymer C and wherein the long chain groups have a bimodal distribution of carbon chain lengths.

37. A blend according to claim 32 wherein esters 1 and 3 are derived from acrylic acid an alcohol of 16, 18, 20, 22 or 24 carbons for ester 1 and 1-4 carbons for ester 3.

38. A blend according to claim 37 wherein the alcohol is a mixture of alcohols with differences in carbon numbers of at least 3.

39. A blend according to claim 23 wherein the average carbon chain length in the totality of the long chain groups is 15.5-22.5, especially 18.5-21.5.

40. A blend according to claim 23 wherein the average chain length in the totality of polymers i-iii is 12-18, especially 13.5-15-5.

41. A blend according to claim 23 which comprises component (iv) and at least one of components (i)-(iii).

42. A blend according to claim 41 wherein the additive has a polar group comprising 1-4 nitrogen atoms.

43. A blend according to claim 42 wherein the additive is a mono-N long chain hydrocarbyl substituted alkylene diamine.

44. A blend according to claim 42 wherein the additive is a mono-N long chain hydrocarbyl-nitrogen heterocyclic compound with 2 ring nitrogen atoms.

45. A blend according to claim 34 which comprises at least 2 different copolymer C, wherein the 16-24 carbon alcohols are different by at least 3 carbon numbers.

46. A blend according to claim 23 wherein polymer v is a reaction product of polyalkylene imine with a long chain alkylene oxide.

47. A blend according to claim 46 wherein the long chain alkylene oxide has 16-24 carbon atoms.

48. A blend according to claim 46 which comprises polymer (iii) and (v).

49. A crude oil or condensate therefrom which comprises a polymer of a monomer with structural units derived from at least one ester (i) of an aliphatic carboxylic acid with an aliphatic alcohol, wherein one of the acid and alcohol is ethylenically unsaturated and the other of the acid and alcohol has a long chain group of 14-40 carbons, and a monomer with structural units derived from a corresponding ester (3) with structural units derived from an aliphatic carboxylic acid and an aliphatic alcohol, wherein one of the acid and alcohol is ethylenically unsaturated and the other has an aliphatic group of 1-13 carbons, such that at least 50% of the said aliphatic groups have 15-35 carbons, and if the polymer contains structural units from esters from methacrylic acid, then the molecular weight of the polymer is at least 40000.

50. A crude oil or condensate therefrom which comprises a polymer of monomers with structural units derived from at least one ester (1) and at least one ester (3) as defined in claim 49, and at least 30% of the aliphatic groups are saturated with 15-35 carbons, and if the ester is from a long chain saturated alcohol then said polymer consists essentially of structural units of ester 1 and 3 and at least 40% of the aliphatic groups are saturated with 15-35 carbons, and if the polymer contains structural groups from esters from methacrylic acid, the molecular weight of the polymers is at least 40000.

51. A crude oil or condensate therefrom which comprises a polymer of monomers with structural units derived from at least one ester (1) and at least one ester (3) as defined in claim 49, and at least 30% of the aliphatic groups are unsaturated with 15-35 carbons.

52. An oil or condensate according to claim 49, wherein the copolymer is obtainable by or obtained by transesterification of at least one polymer of ester 3 with an aliphatic alcohol or carboxylic acid with an aliphatic 15-35 carbon atom group (depending on whether the acid or alcohol in ester 1 is unsaturated or aliphatic).

53. An oil or condensate according to claim 50, wherein the copolymer is obtainable by or obtained by transesterification of at least one polymer of ester 3 with an aliphatic alcohol or carboxylic acid with an aliphatic 15-35 carbon atom group (depending on whether the acid or alcohol in ester 1 is unsaturated or aliphatic).

54. An oil or condensate according to claim 51, wherein the copolymer is obtainable by or obtained by transesterification of at least one polymer of ester 3 with an aliphatic alcohol or carboxylic acid with an aliphatic 15-35 carbon atom group (depending on whether the acid or alcohol in ester 1 is unsaturated or aliphatic).

55. A crude oil or condensate therefrom, which comprises a blend of at least 2 components selected from
group (i) homopolymers (A) with structural units derived from an ester (1) of an aliphatic carboxylic acid with an aliphatic alcohol, wherein one of the acid and alcohol is ethylenically unsaturated and the other of the acid and alcohol has a long chain group of 14-40 carbons,
group (ii) copolymers (B) thereof with structural units derived from a different ester (2) within the same definition as ester 1, such that the mole average carbon content of the long chain group is 15-35 or that at least 30% of the long chain groups have 15-35 carbons preferably 16.5-24 especially 18-22 carbons
group (iii) copolymers (C) of said ester (1) and optionally ester (2) with a corresponding ester (3) with structural units derived from an aliphatic carboxylic acid and an aliphatic alcohol, wherein one of the acid and alcohol is ethylenically unsaturated and the other has an aliphatic group of 1-13 carbons, such that at least 30% of the said aliphatic groups have 15-35 carbons, and
group (iv) monomeric additives, which have an aliphatic group of at least 14 carbon atoms and a polar group,
group (v) at least one N-substituted polyalkylene imine compound with chain nitrogen atoms, which has at least one organic substituent of at least 6 carbon atoms on at least one nitrogen atom,
with the proviso that the blend contains at least one of (i)-(iii) and (v), and, unless the blend contains a copolymer (iii), then the blend contains at least one component from more than one group, and with the proviso that when the blend is of a homopolymer (i) from an ester from an ethylenically unsaturated carboxylic acid and a saturated aliphatic alcohol and a copolymner (iii) from esters from an ethylenically unsaturated acid and a saturated aliphatic alcohol, then the molecular weight of copolymer (iii) is at least 40000.

56. A method of reducing wax formation or deposition in a wax containing crude oil or condensate therefrom, which comprises mixing with said oil or condensate a polymer of a monomer with structural units derived from at least one ester (i) of an aliphatic carboxylic acid with an aliphatic alcohol, wherein one of the acid and alcohol is ethylenically unsaturated and the other of the acid and alcohol has a long chain group of 14-40 carbons, and a monomer with structural units derived from a corresponding ester (3) with structural units derived from an aliphatic carboxylic acid and an aliphatic alcohol, wherein one of the acid and alcohol is ethylenically unsaturated and the other has an aliphatic group of 1-13 carbons, such that at least 50% of the said aliphatic groups have 15-35 carbons, and if the polymer contains structural units from esters from methacrylic acid, then the molecular weight of the polymer is at least 40000.

57. A method of reducing wax formation or deposition in a wax containing crude oil or condensate a polymer of monomers with structural units derived from at least one ester (1) and at least one ester (3) as defined in claim 56, and at least 30% of the aliphatic groups are saturated with 15-35 carbons, and if the ester is from a long chain saturated alcohol then said polymer consists essentially of structural units of ester 1 and 3 and at least 40% of the aliphatic groups are saturated with 15-35 carbons, and if the polymer contains structural groups form esters from methacrylic acid, the molecular weight of the polymers is at least 40000.

58. A method of reducing wax formation or deposition in a wax containing crude oil or condensate therefrom, which comprises mixing with said oil or condensate a polymer of monomers with structural units derived from at least one ester (1) and at least one ester (3) as defined in claim 56, and at least 30% of the aliphatic groups are unsaturated with 15-35 carbons.

59. A method according to claim 56, wherein the copolymer is obtainable by or obtained by transesterification of at least one polymer of ester 3 with an aliphatic alcohol or carboxylic acid with an aliphatic 15-35 carbon atom group (depending on whether the acid or alcohol in ester 1 is unsaturated or aliphatic).

60. A method according to claim 56 wherein said oil is flowing in a pipeline.

61. A method according to claim 56 wherein said polymer or copolymer is mixed with the oil in an amount of 10-10000 ppm based on the weight of the oil.

62. A method according to claim 56 wherein said oil is a crude hydrocarbon oil of Wax Appearance Temperature of 10-50° C.
